(19) United States
(12) Patent Application Publication
(10) Pub. No.: US 2007/0218990 A1
(43) Pub. Date: Sep. 20, 2007

(54) Gaming machine and game system

(75) Inventor: Kazuo Okada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: ARUZE CORP., Tokyo (JP)

(21) Appl. No.: 11/374,477

(22) Filed: Mar. 14, 2006

(51) Int. Cl. A63F 13/00

(52) U.S. Cl. 463/31

(57) ABSTRACT

A gaming machine of the present invention comprises: display means for displaying plural types of images including plural types of reach effect images displayed until the execution of special games advantageous to a player; display control means for conducting a control for displaying, on the display means, any types of output information images, out of plural types of output information images including output information associated with the respective plural types of reach effect images, in such a manner that the output information images can be captured with image pickup means from the outside; reception means for receiving, from outside, information relating to image data based on the any types of output information image, the image data obtained by capturing by the image pickup means, as an image information associated with the reach effect images; and control means for conducting a control for providing a predetermined benefit, on the condition that the reception means has received image information associated with predetermined types of reach effect images.

### CROSS-REFERENCE TO RELATED APPLICATIONS

The present application relates to Japanese Patent Application No. 2005-10853, filed on Jan. 18, 2005. The contents of this application are incorporated herein by reference in their entirety.

### BACKGROUND OF THE INVENTION

1. Field of the Invention

The present invention relates to a gaming machine and, more particularly, to a gaming machine capable of displaying output information images including predetermined output information.

2. Discussion of the Background

In a conventional pachinko machine, in the event that game balls enter a starting opening, internal lottery is conducted for determining whether or not a big hit should be occurred. If a big hit occurs as a result of the internal lottery, a predetermined combination of special symbols are statically displayed and, then, special games advantageous to a player are performed, wherein during such special games a special winning opening is repeatedly opened and closed plural times. In the conventional pachinko machine, during special games, game balls can easily enter the special winning opening, thereby providing many winning balls to the player.

Further, during special games or during normal games until the transition to special games, on a display device (display means) such as an LCD, special symbols are variably displayed in various manners and various types of effect images are displayed for providing various types of displaying for entertaining the player.

However, there are cases where a player can not win a bit hit even when he or she plays games for a long time, and, as a result, he or she only consumes money and time. In such cases, the player tends to have dissatisfaction and can not enjoy even while seeing ingenious effect images for a long time.

In order to prevent such dissatisfaction, there is a need for providing a new gaming machine to players, in order to cause players to have enthusiasm for games.

Therefore, as a new gaming machine to be provided to players, there has been suggested a gaming machine capable of displaying output information images (for example, images of two-dimensional codes or the like) on a display device including an LCD, wherein the output information images are generated by coding information such as game information. Further, there has been suggested a technique which enables players to capture output information images displayed in a gaming machine, by using a portable telephone or the like capable of reading output information images (refer to JP-A 2004-236902).

However, with the aforementioned gaming machine, output information images are displayed and a player can capture the output information images with a portable telephone to easily acquire predetermined benefits (for example, useful game information) therefrom. As described above, with the conventional gaming machines, on the condition that a player conducts simple operations, he or she is enabled to capture output information images displayed thereon to acquire predetermined benefits, without being required to make efforts during games. Therefore, these machines leave much to be improved, in view of enhancing interests in games.

The contents of JP-A 2004-236902 are incorporated by reference herein in their entirety.

### SUMMARY OF THE INVENTION

The present invention has been made in view of the aforementioned problems. It is an object of the present invention to provide a gaming machine capable of requiring players to make efforts during games as a condition for providing a predetermined benefit to the players to provide a new game aspect, thus enhancing their interests in games.

In order to attain the aforementioned object, the present invention provides the following configurations.

(1) A gaming machine comprising:

display means for displaying plural types of images including plural types of reach effect images displayed until the execution of special games advantageous to a player;

display control means for conducting a control for displaying, on the display means, any types of output information images, out of plural types of output information images including output information associated with the respective plural types of reach effect images, in such a manner that the output information images can be captured with image pickup means from the outside;

reception means for receiving, from outside, information relating to image data based on the any types of output information image, the image data obtained by capturing by the image pickup means, as an image information associated with the reach effect images; and

control means for conducting a control for providing a predetermined benefit, on the condition that the reception means has received image information associated with predetermined types of reach effect images.

(2) A game system comprising:

a gaming machine including display means for displaying plural types of images including plural types of reach effect images displayed until the execution of special games advantageous to a player, and display control means for conducting a control for displaying, on the display means, any types of output information images, out of plural types of output information images including output information associated with the respective plural types of reach effect images, in such a manner that the output information images can be captured with image pickup means from the outside; and

a server capable of transmitting and receiving information to and from the outside via a communication line, wherein

the server includes:

reception means for receiving, from outside, information relating to image data based on the any types of output information image, the image data obtained by capturing by the image pickup means, as an image information associated with the reach effect images; and

benefit information transmission means for transmitting, to the outside, information relating to a predetermined benefit, on the condition that the reception means has received image information associated with predetermined types of reach effect images.

According to the configuration (1) or (2), in the configuration that any types of output information images are captured by the image pickup means from the outside out of plural types of output information images including output information associated with each of plural types of reach effect images, and information relating to the image data obtained by the capturing and based on the output information image, is received from the outside as image information in accordance with a reach effect image, on the condition that image information associated with predetermined types of reach effect images has been received, a predetermined benefit is provided to the player. Namely, as a condition for providing a predetermined benefit, the following actions should be performed for predetermined types of reach effect images, which requires the player to make efforts during games. For example, the player should capture output information images associated with plural types of reach effect images from the outside with the image pickup means to generate image data, and then should transmit image information based on the image data which is in association with the reach effect images to the reception means. As described above, as a condition for providing a predetermined benefit to the player, the player is required to make efforts during games, which provides a new game aspect to the player, thereby enhancing his or her interest in games.

With the present invention, on the condition that output information images including output information associated with plural types of reach effect images are captured from outside by the image pickup means to generate image data and, further, predetermined types of image information association with the reach effect images relating to the image data have been received, a predetermined benefit is provided to the player, which provides a new game aspect to the player, thereby enhancing his or her interest in games.

### BRIEF DESCRIPTION OF THE DRAWINGS

FIG. 1 is a perspective view illustrating the general view of a system according to an embodiment of the present invention;

FIG. 2 is a perspective view illustrating the general view of a pachinko gaming machine according to the embodiment of the present invention;

FIG. 3 is an exploded perspective view illustrating the general view of the pachinko gaming machine according to the embodiment of the present invention;

FIG. 4 is a front view illustrating an electric decoration unit configured in the pachinko gaming machine according to the embodiment of the present invention;

FIG. 5 is a front view illustrating the general view of the pachinko gaming machine according to an embodiment of the present invention;

FIG. 6 is an explanation view illustrating a display screen being displayed in the pachinko gaming machine according to the embodiment of the present invention;

FIG. 7 is an explanation view illustrating a display screen being displayed in the pachinko gaming machine according to the embodiment of the present invention;

FIG. 8 is an explanation view illustrating a display screen being displayed in the pachinko gaming machine according to the embodiment of the present invention;

FIG. 9 is an explanation view illustrating a display screen being displayed in the pachinko gaming machine according to the embodiment of the present invention;

FIG. 10 is an explanation view illustrating a display screen being displayed in the pachinko gaming machine according to the embodiment of the present invention;

FIG. 11 is an explanation view illustrating an output information image being displayed in the pachinko gaming machine according to the embodiment of the present invention;

FIG. 12 is a view illustrating an output information table in the pachinko gaming machine according to the embodiment of the present invention;

FIG. 13 is a block diagram illustrating a main control circuit and a sub control circuit structured in the pachinko gaming machine according to the embodiment of the present invention;

FIG. 14 is flowchart illustrating a control process which is conducted in the pachinko gaming machine according to the embodiment of the present invention;

FIG. 15 is a flowchart illustrating a control process which is conducted in the pachinko gaming machine according to the embodiment of the present invention;

FIG. 16 is a flowchart illustrating a control process which is conducted in the pachinko gaming machine according to the embodiment of the present invention;

FIG. 17 is an explanation view illustrating state transition of a control process which is conducted in the pachinko gaming machine according to the embodiment of the present invention;

FIG. 18 is a flowchart illustrating a control process which is conducted in the pachinko gaming machine according to the embodiment of the present invention;

FIG. 19 is a flowchart illustrating a control process which is conducted in the pachinko gaming machine according to the embodiment of the present invention;

FIG. 20 is a flowchart illustrating a control process which is conducted in the pachinko gaming machine according to the embodiment of the present invention;

FIG. 21 is a block diagram illustrating a circuit structured in a portable telephone according to an embodiment of the present invention;

FIG. 22 is a block diagram illustrating a circuit structured in a server according to an embodiment of the present invention;

FIG. 23 is a flowchart illustrating a control process which is conducted in a system according to an embodiment of the present invention;

FIG. 24 is a flowchart illustrating a control process which is conducted in a system according to an embodiment of the present invention;

FIG. 25 is a view illustrating an image information table in a system according to an embodiment of the present invention;

FIG. 26 is a view illustrating a benefit table in a system according to an embodiment of the present invention;

FIG. 27 is a flowchart illustrating a control process which is conducted in a system according to an embodiment of the present invention; and

FIG. 28 is a view illustrating a data table in a system according to an embodiment of the present invention.

### DESCRIPTION OF THE EMBODIMENTS

Hereinafter, a preferred embodiment of the present invention will be described with reference to the drawings. In the following description of the embodiment, there will be described a case where the present invention is applied to a first type of a pachinko gaming machine (also referred to as “digi-pachi”) as a preferred embodiment of a gaming machine according to the present invention.

(System Structure)

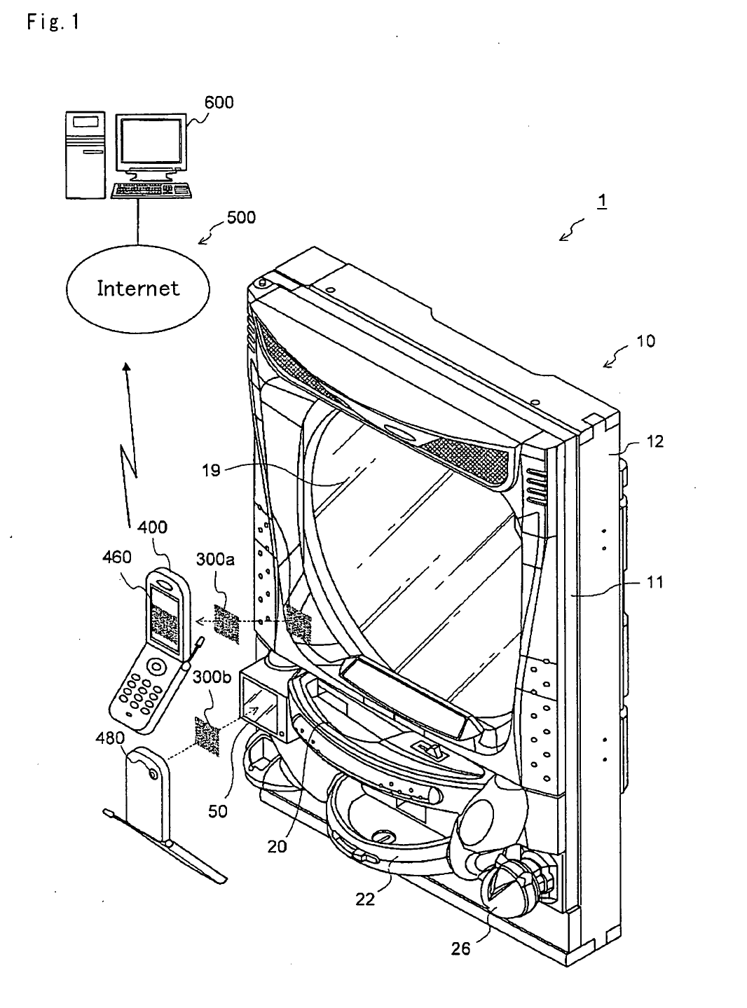

First, the general outline of the system will be described with reference to FIG. 1. FIG. 1 is a view illustrating the structure of a system. The system 1 includes a pachinko gaming machine 10 which functions as a display device, a portable terminal device 400 which functions as image pickup means capable of receiving output information images from the pachinko gaming machine 10, and a server 600 capable of transmitting and receiving information to and from the portable terminal device 400 through the Internet 500.

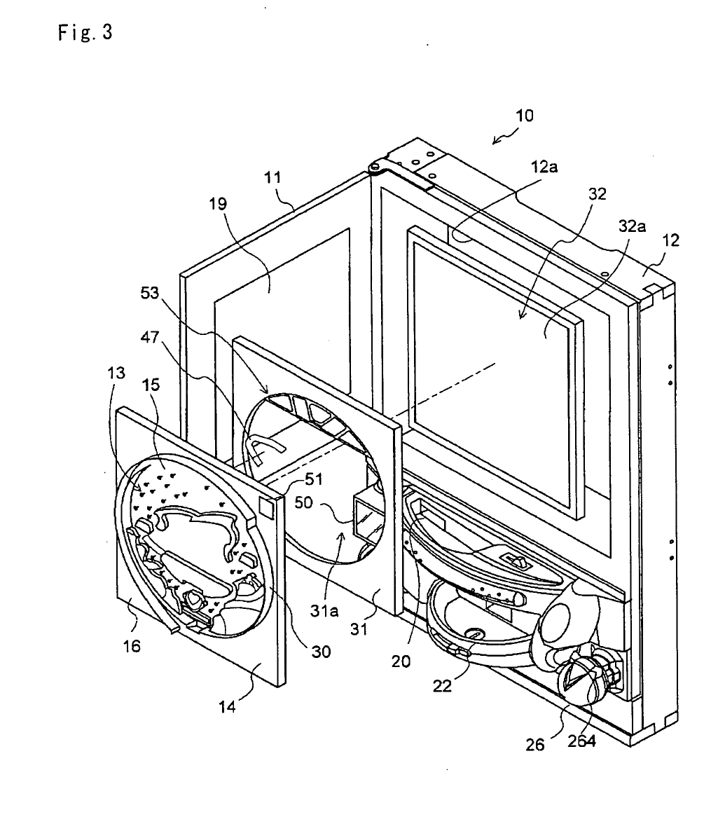

As will be described in detail later, in the system 1, plural types of reach effect images are displayed on a display region 32a (see FIG. 3) of a liquid crystal display device 32 of the pachinko gaming machine 10. Further, output information images (for example, images of two-dimensional codes 300a and the like) including output information (for example, service points, game information and the like) associated with the respective plural types of reach effect images are displayed. The output information images are captured by the image pickup means (for example, a CCD camera 480 and the like) of the portable terminal device 400, and the portable terminal device 400 generates image information on the basis of the captured output information images. Further, the portable terminal device 400 displays the generated image information on the liquid crystal panel 460 for transmitting the generated image information to the pachinko gaming machine 10. The pachinko gaming machine 10 receives the image information through reception means (for example, a reading device 50). Namely, the reception means of the gaming machine 10 receives image information associated with reach effect images from the outside. Then, on the condition that image information associated with predetermined types of reach effect images has been received, a predetermined benefit (for example, a special image, music or the like) is provided to a player.

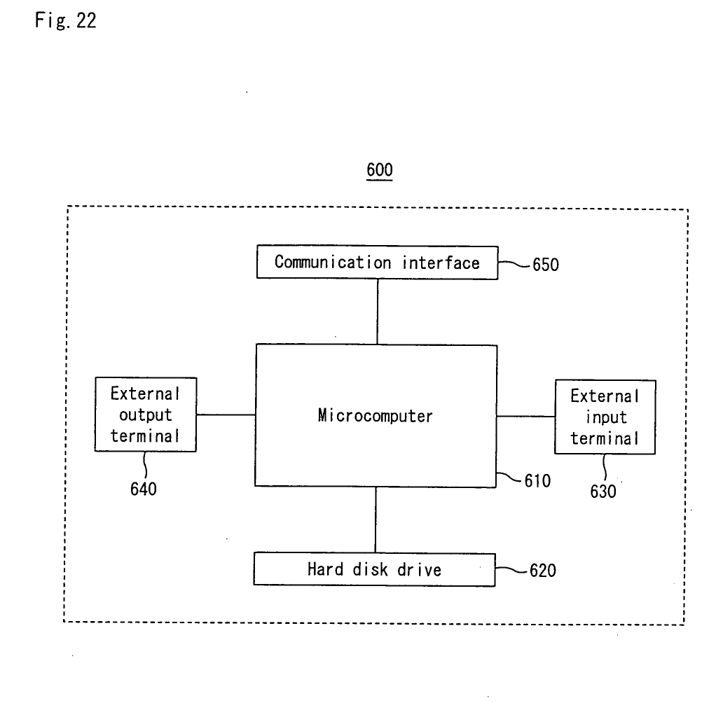

Further, in the system 1 according to the present invention, plural types of reach effect images are displayed on the display region 32a (see FIG. 3) of a liquid crystal display device 32 of the pachinko gaming machine 10. Further, output information images (for example, images of two-dimensional codes 300a and the like) including output information (for example, service points, game information and the like) associated with the respective plural types of reach effect images are displayed. The output information images are captured by the image pickup means (for example, a CCD camera 480) of the portable terminal device 400, and the portable terminal device 400 generates image information on the basis of the captured output information images. Further, the portable terminal device 400 transmits the generated image information to the server 600, through the Internet 500. The server 600 receives the image information through reception means (for example, a communication interface 650 (see FIG. 22) and the like). Namely, the reception means of the server 600 receives image information associated with the reach effect images from the outside. Then, on the condition that image information associated with predetermined types of reach effect images has been received, benefit information transmission means (for example, a communication interface 650) in the server 600 transmits information relating to a predetermined benefit (for example, special images, music or the like) to the portable terminal device 400, through a communication line.

As described above, output information images including output information associated with respective plural types of reach effect images are captured by the image pickup means from the outside and, as a result, image data based on the any types of output information images is generated, and information relating to the resultant image data is received from outside, as image information associated with the reach effect images. Further, on the condition that image information associated with predetermined types of reach effect images has been received by the pachinko gaming machine 10 or the server 600, a predetermined benefit is provided to the player. Namely, in order to provide a predetermined benefit, the following actions should be performed for the predetermined types of reach effect images, which requires the player to make efforts during games. That is, for example, output information images associated with plural types of reach effect images are captured by the image pickup means from the outside to generate image data, and image information associated with the reach effect images, which is based on the resultant image data, is transmitted to the reception means. As described above, as a condition for providing a predetermined benefit to the player, the player is required to make efforts during games, which provides a new game aspect to the player, thereby enhancing his or her interest in games.

In the present embodiment, there will be described a case where a two-dimensional code is used as an output information image, the output information image according to the present invention is not limited to a two-dimensional code and may also include an one-dimensional code (a bar code). Further, while, in the present embodiment, there will be described a case where QR codes (registered trademark) are employed as two-dimensional codes, the present invention is not limited to the case and covers other types of two-dimensional codes such as DataMatrix (registered trademark), and PDF417.

Further, while, in the present embodiment, there will be described a case where a two-dimensional code 300a is captured and received by the image pickup means (the CCD camera 480) included in the portable terminal device 400, the present invention is not limited to the case and may employ, for example, a personal digital assistance (PDA), a dedicated portable terminal device for the aforementioned service supplying system, instead of the portable telephone.

(Structure of Gaming Machine)

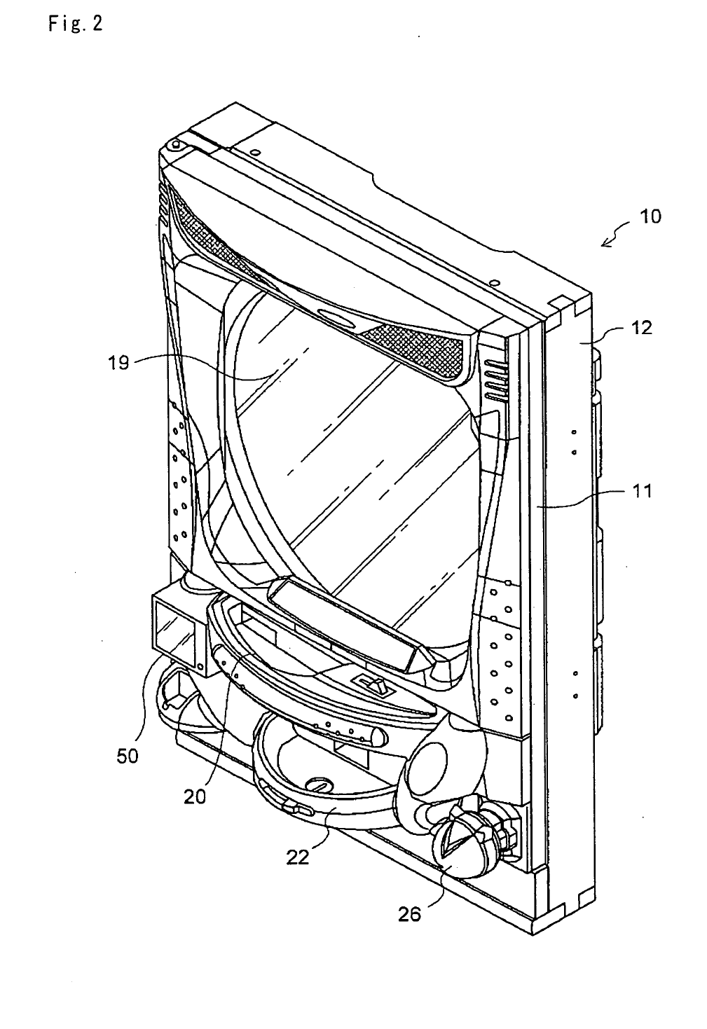

Next, with reference to FIG. 2 and FIG. 3, the general view of the gaming machine will be described in detail. FIG. 2 is a perspective view illustrating the general view of the pachinko gaming machine 10 according to the present embodiment. FIG. 3 is an exploded perspective view illustrating the general view of the pachinko gaming machine 10 according to the present embodiment.

As illustrated in FIGS. 2 and 3, the pachinko gaming machine 10 is constituted by a main body frame 12 having an opening 12a formed through its front surface, various types of components placed within the opening 12a of the main body frame 12, and a door 11 pivotally and openably mounted to the main body frame 12 at the front side thereof. As illustrated in FIG. 2, the door 11 is for closing the opening 12a at the front side thereof and is usually kept closed during games. Further, there are placed an upper plate 20, a lower plate 22, a shooting handle 26, the reading device 50 as reception means, and the like, on the front surface of the main body frame 12.

As will be described later, there are placed, within the opening 12a of the main body frame 12, the liquid crystal display device 32 as display means for displaying images, a spacer 31, a game board 14 and the like. Further, for ease of understanding, description of various types of components (not shown) other than the gaming board 14, the spacer 31 and the liquid crystal display device 32 will be omitted.

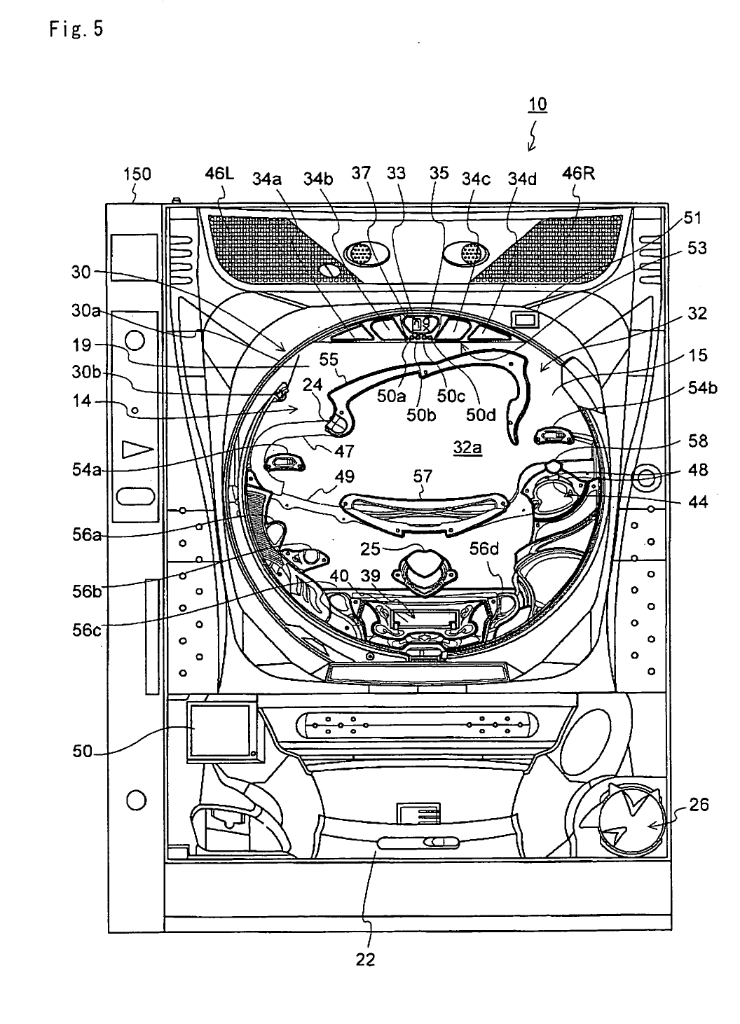

The gaming board 14 is entirely formed from a plate-shaped transparent resin (a transparent member). Such a transparent member may be various types of materials, such as an acrylic resin, a polycarbonate resin, a methacrylic resin. Further, the gaming board 14 includes, at its front side, a game region 15 which allows launched gaming balls to roll thereon. The game region 15 is a region which is surrounded by a guide rail 30 (more specifically, an outer rail 30a illustrated in FIG. 5, which will be described later) and enables gaming balls to roll thereon. Further, plural nails 13 are driven into the game region 15 of the gaming board 14. Further, near the upper right end portion of the outer rail 30a, on the game board 14, there is provided a number-of-rounds display device 51 as a number-of-rounds display means.

As described above, since the number-of-rounds display means for displaying the number of rounds during special games is provided separately from the display means for displaying effect images, it is possible to appropriately and clearly display the number of rounds.

The liquid crystal display device 32 is placed behind the gaming board 14 (in the side of the back surface thereof) with the spacer 31 interposed therebetween. Namely, the liquid crystal display device 32 is placed behind the transparent member forming the gaming panel 14. The liquid crystal display device 32 has a display region 32a capable of displaying images relating to games. The display region 32a is placed such that the display region 32 is entirely or partially overlapped with the gaming board 14 from the side of the back surface thereof with the spacer 31 sandwiched therebetween. In other words, the display region 32a is placed behind the gaming board 14 such that it is at least entirely or partially overlapped with the game region 15 of the gaming board 14. More specifically, the liquid crystal display device 32 is placed behind the gaming board 14 such that the display region 32a thereof is entirely or partially overlapped with the game region 15 and also is entirely or partially overlapped with the outside region 16 of the game region. On the display region 32a of the liquid crystal display device 32, various types of images such as effect images for effects, decoration images for decoration are displayed. Particularly, after the transition to a big-hit game state, an effect image for an effect is displayed during special games, on the display region 32a of the liquid crystal display device 32.

By providing the display means such as the liquid crystal display device 32 behind the transparent game board 14 in the present embodiment, it is possible to expand the region in which nails can be driven and the region in which gaming members such as combination members, decoration members can be provided and also it is possible to further increase the degree of freedom in layout.

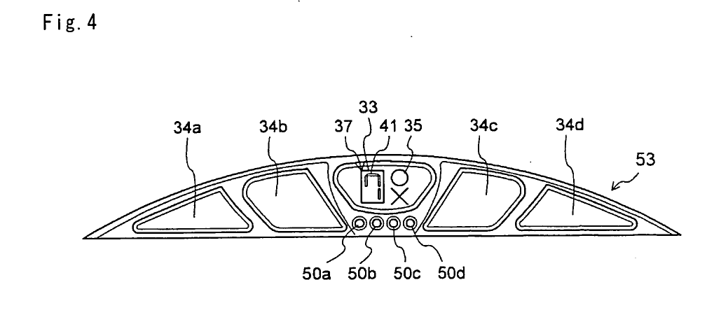

The spacer 31 is placed behind the gaming board 14 (in the side of the back surface thereof) and also is placed at the front of the liquid crystal display device 32 (in the side of the front surface thereof). Namely, the spacer 31 is sandwiched between the gaming board 14 and the liquid crystal display device 32. The spacer 31 is made of a transparent material and is provided with a large through hole 31a at the center thereof. An electric decoration unit 53 is provided within the through hole 31a. The electric decoration unit 53 is constituted by a display device case 37 housing a special symbol display device 33 and a normal symbol display device 35, special symbol hold lamps 34a, 34b, 34c and 34d and normal symbol hold lamps 50a, 50b, 50c and 50d, as illustrated in FIG. 4. The display device case 37 is covered, at its front side, with a transparent lens (not shown), in order to improve the view-ability.

In FIG. 3, for ease of understanding, there is illustrated a first warp path 47 provided on the back surface of the game board 14. The first warp path 47 is made of a transparent material and is provided for transferring gaming balls which entered a winning opening 24 (see FIG. 5) to a second warp path 49 which will be described later (see FIG. 5).

with reference to FIG. 4, the special symbol display device 33, the normal symbol display device 35, the special symbol hold lamps 34a to 34d and the normal symbol hold lamps 50a to 50d will be described. FIG. 4 is an enlarged view of the electric decoration unit 53.

As illustrated in FIG. 4, the special symbol display device 33 housed in the display device case 37 is constituted by plural 7-segment LEDs 41. The 7-segment LEDs 41 are repeatedly turned on and off, when a predetermined special symbol variable display starting condition is satisfied. When the 7-segment LEDs 41 are turned on and off, ten numerical symbols from “0” to “9” are variably displayed as special symbols (also referred to as identification information). If a specific numerical symbol (for example, a numerical symbol of “3” or “7”) is statically displayed as a special symbol, then the game state is changed from a normal game state to a big-hit game state (special game state) advantageous to the player. In the event that the game state enters such a big-hit game state, a shutter 40 (see FIG. 5) is controlled to be in a state of open, which enables a special winning opening 39 (see FIG. 5) to receive gaming balls, as will be described later. On the other hand, if a numerical symbol other than the specific numerical symbol (for example, a numerical symbol other than “3” or “7”) is statically displayed as a special symbol, the normal game state is maintained. Games as described above are referred to as “special symbol games”, during which special symbols are variably displayed and then statically displayed and, depending on the result of the static displaying of special symbols, the game state is changed or maintained.

The normal symbol display device 35 is provided at the right of the special symbol display device 33. The normal symbol display device 35 is constituted by two display lamps (not shown) and, these display lamps are alternately turned on and off, thereby for example a round mark and a cross mark are variably displayed as normal symbols.

The special symbol hold lamps 34a to 34d are provided at the right and left of the display device case 37. The special symbol hold lamps 34a to 34d indicate the number of times the variable display of special symbols has been held (so-called, “the number of holds”, “the number of holds relating to special symbols”) by turning on or off. For example, when the variable display of special symbols has been held a single time, the special symbol hold lamp 34a is lighted.

The normal symbol hold lamps 50a to 50d are provided under the display device case 37. The normal symbol hold lamps 50a to 50d indicate the number of times the variable display of the normal symbols has been held (so-called, “the number of holds”, “the number of holds relating to the normal symbols”) by turning on and off, as will be described later. Similarly to special symbols, when the variable display of the normal symbols has been held a single time, the normal symbol hold lamp 50a is lighted.

The description of the external view of the pachinko gaming machine 10 will be continued using FIG. 2 and FIG. 3. A transparent protective plate 19 is placed on the door 11. The transparent protective plate 19 is placed such that it is faced to the front surface of the gaming board 14 in the state where the door 11 is closed.

The launching handle 26 is provided rotatably with respect to the main body frame 12. At the back side of the launching handle 26, there is provided a launching solenoid (not shown) which is a driving device. At the periphery portion of the launching handle 26, there is provided a touch sensor (not shown). When the player touches the touch sensor, it is detected that the player grasps the launching handle 26. When the player grasps the launching handle 26 and rotates it in the clockwise direction, the launching solenoid is fed with electric power depending on the angle of rotation, which causes gaming balls stored on the upper plate 20 to be successively launched to the gaming board 14 for progressing games. At the periphery of the shooting handle 26, there is provided an operating switch 264. The reading device 50 is provided near the lower left portion of the main body frame 12.

The player can place the two-dimensional code 300b displayed on the liquid crystal panel 460 (see FIG. 1) of the portable terminal device 400 oppositely to the reading device 50 and can push the operating switch 264 for causing the reading device 50 to read the two-dimensional code 300b.

On the display region 32a of the liquid crystal display device 32 placed behind the gaming board 14 (in the side of the back surface thereof), an effect image relating to a special symbol being displayed on the aforementioned special symbol display device 33 is displayed.

As will be described in detail later, during the variation display of special symbols on the special symbol display device 33, symbols consisting of numerical characters, marks and the like (which are also effect identification information such as, for example, numerical characters from “0” to “9”) are variably displayed in the respective plural symbol rows (three rows, in the present embodiment), on the display region 32a of the liquid crystal display device 32. Further, after the variation display of special symbols in the special symbol display device 33, a special symbol is statically displayed and also an effect identification information is statically displayed on the display region 32a of the liquid crystal display device 32.

Further, if a specific numerical symbol (for example, a numerical symbol of “7”) is statically displayed as a special symbol on the special symbol display device 33, an effect image which notifies the player of the occurrence of a big hit is displayed on the display region 32a of the liquid crystal display device 32. More specifically, if a specific numerical symbol is statically displayed as a special symbol on the special symbol display device 33, the combination of effect identification information being displayed on the display region 32a of the liquid crystal display device 32 is brought into a specific display state (for example, a state where any one of the numerical numbers “1” to “9” is statically displayed in all the plural symbol rows), and also a letter image describing “Big Hit!!” is displayed along with a character image illustrating a delighting character, on the display region 32a of the liquid crystal display device 32.

Next, with reference to FIG. 5, the general view of the pachinko gaming machine 10 will be described in detail. FIG. 5 is a front view illustrating the general view of the pachinko gaming machine 10 according to the present embodiment. While the general view of the pachinko gaming machine 10 will be described with reference to FIG. 5, the portions of the external view of the pachinko gaming machine 10 which have been previously described with reference to FIG. 2 and FIG. 3 will not be redundantly described. Further, in FIG. 5, illustration of the plural nails 13 driven into the gaming board 14 is omitted.

As illustrated in FIG. 5, there are provided, on the gaming board 14, two guide rails 30 (30a and 30b) and gaming members such as obstruction members 55 and 57, passage gates 54a and 54b, a second warp path 49, an obstruction member 58, a starting opening 25, a starting opening 44 including blade members 48, a shutter 40, a special winning opening 39, a number-of rounds display device 51, regular winning openings 56a, 56b, 56c and 56d. Further, at the upper portion of the gaming board 14, the electric decoration unit 53 including the special symbol display device 33, the normal symbol display device 35 and the like is viewable.

The obstruction member 55 is provided on the gaming board 14 at an upper portion thereof and the obstruction member 57 is provided on the gaming board 14 substantially at the center portion thereof. Further, the obstruction member 58 is provided on the gaming board 14 at the right of the center portion thereof.

The two guide rails 30 provided on the gaming board 14 at the left side thereof are constituted by an outer rail 30a bounding (defining) the game region 15 and an inner rail 30b placed inside the outer rail 30a. Launched gaming balls are guided by the guide rail 30 provided on the gaming board 14, then moved to the upper portion of the gaming board 14, passed over the electric decoration unit 53 and then flowed toward the down side of the gaming board 14 while colliding against the aforementioned plural nails (not shown), the obstruction members 55, 57 and 58 and the like provided on the gaming board 14 to change the direction of movement thereof.

Further, the winning opening 24 is formed at the left end portion of the obstruction member 55. If gaming balls enter the winning opening 24, the gaming balls are passed through the first warp path 47 behind the gaming board 14, then are moved along the rail-shaped second warp path 49 and then are directed to the back side of the obstruction member 57. The gaming balls directed to the back side of the obstruction member 57 are ejected to the front side of the gaming board 14 through the ejecting opening (not shown) surrounded by the obstruction member 57 and then flowed downwardly toward the gaming board 14.

Further, the starting opening 44 is provided at the right of the obstruction member 55. The blade members (so-called normal electric combination members) 48 are provided at the right and left of the starting opening 44.

In the event that a game ball enters the aforementioned starting opening 25 or the starting opening 44 (which is one of predetermined special symbol variation display starting conditions), the special symbol display device 33 starts the variation display of special symbols.

Also, if a gaming ball enters the aforementioned starting opening 25 or the starting opening 44 during variable displaying of special symbols, the execution (start) of variable display of special symbols on the basis of the entry of the gaming ball into the starting opening 25 or the starting opening 44 is held until the currently-executed variable display of special symbols ends and a special symbol is statically displayed.

Herein, there is placed an upper limit on the number of times the execution of the variation display of special symbols is held and, for example, the variation display of special symbols can be held up to four times as an upper limit.

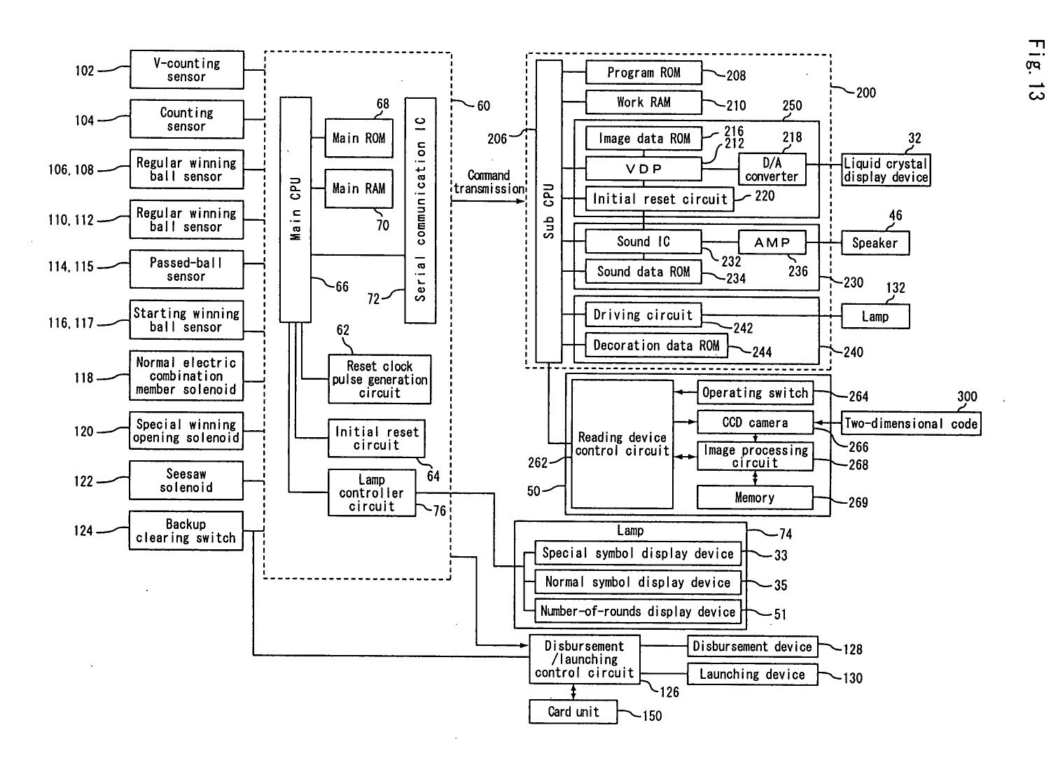

The passage gates 54a and 54b are provided on the gaming board 14 at the right and left sides thereof substantially at the middle position. In the passage gates 54a and 54b, there are provided passed-ball sensors 114 and 115 (see FIG. 13), which will be described later. The passed-ball sensors 114 or 115 detect gaming balls being passed through the passage gates 54a or 54b. In the event that the passed-ball sensor 114 or 115 detects a gaming ball being passed therethrough, the normal symbol display device 35 starts to variably display the normal symbols and, after the elapse of a predetermined time, the normal symbol display device 35 stops the variable display of the normal symbols. As previously described, the normal symbols are symbols such as a round mark, a cross mark and the like.

If this normal symbol is statically displayed as the predetermined symbol, for example, the round mark, the blade members (so-called normal electric combination members) 48 provided at the right and left of the starting opening 44 are brought into an opened state from the closed state, which causes gaming balls to easily enter the starting opening 44. Further, when a predetermined time has elapsed since the blade members 48 are opened, the blade members 48 are brought into the closed state, which reduces the probability of entry of gaming balls into the starting opening 44. Games as aforementioned are referred to as “normal symbol games”, during which normal symbols are variably displayed and then statically displayed and, depending on the static displaying of normal symbols, the opening/closing state of the blade members 48 is varied.

Similarly to variable display of special symbols, if gaming balls pass through the passage gates 54a and 54b during variable display of normal symbols, the execution (start) of variable displaying of normal symbols on the basis of the passage of the gaming balls through the passage gates 54a and 54b is held until the currently-executed variable display of normal symbols ends and a normal symbol is statically displayed. Thereafter, when a single normal symbol which has been variably displayed is statically displayed, the variable display of normal symbols which has been held is started.

The openable shutter 40 is provided at the front side of the special winning port 39 (at the front thereof). In the event that a specific numerical symbol is statically displayed as a special symbol on the special symbol display device 33 and the game state enters a big-hit game state, the shutter 40 is driven into the opened state where it can easily receive gaming balls. As a result, the special winning port 39 is brought into an opened state (a first state) where it can easily receive gaming balls.

On the other hand, the special winning port 39 provided in the side of the back side of the shutter 40 (behind the shutter 40) has a specific region (not shown) provided with a V-counting sensor 102 (see FIG. 13) and a normal region (not shown) provided with a counting sensor 104 (see FIG. 13) and the shutter 40 is kept driven into the opened state, until a predetermined number (for example, ten) of gaming balls have passed through these regions or until a predetermined time (for example, 30 seconds) has elapsed. If the condition relating to the entry of the predetermined number of gaming balls into the special winning opening 39 or the condition relating to the elapse of the predetermined time is satisfied during the opened state, the shutter 40 is driven into the closed state where it can not easily receive gaming balls. As a result, the special winning opening 39 is brought into a closed state (a second state) where it can not easily receive gaming balls. A game which starts at the time the special winning port 39 is brought into the opened state (the first state) where it can easily receive gaming balls and ends at the time the special winning port 39 is brought into the closed state (the second state) where it can not easily receive gaming balls is referred to as a round game. Accordingly, the shutter 40 is kept opened during round games while it is closed at intervals between round games. Further, such round games are counted as the number of rounds such as “1” round, “2” rounds. Further, for example, a first round game may be referred to as “a first” round and a second round game may be referred to as “a second” round.

Subsequently, the shutter 40 driven into the closed state (the second state) from the opened state is driven into the opened state again, on the condition that a gaming ball enters the special winning opening 39 and passes through the V-counting sensor 102 during the opened state. Namely, on the condition that a gaming ball enters the special winning opening 39 and passes through the V-counting sensor 102 during the opened state of the shutter 40, the game state can continuously proceeds to the next round game. A game which starts with a “first” round game and ends with a (final) round game which can not proceed to the next round game is referred to as a special game.

During special games, the number of rounds (the maximum number of continuous rounds) from the first round to the final round game, in cases where round games continue as many as possible, is varied depending on the special symbol which is statically displayed. For example, in the present embodiment, if a numerical symbol of “3” is statically displayed on the special symbol display device 33, the maximum number of continuous rounds is 2 rounds and, if a numerical symbol of “7” is statically displayed on the special symbol display device 33, the maximum number of continuous rounds is 15 rounds. However, the maximum number of continuous rounds is not limited to 2 rounds or 15 rounds. For example, the maximum number of continuous rounds may be selected from “1” to “15” rounds, through lottery using a number-of-rounds lottery means (the main control circuit 60 (see FIG. 13) including a main CPU 66, which will be described later).

On the other hand, the number-of-rounds display device 51 is provided in a game-region outside region 16 on the game board 14. As illustrated in FIG. 5, the number-of-rounds display device 51 is provided on the game board 14. Since the liquid crystal display device 32 is placed behind the transparent member of the game board 14, the number-of-rounds display device 51 is provided at the front of the liquid crystal display device 32.

Further, the number-of-rounds display device 51 is constituted by at least one 7-segment LED 52 (two 7-segment LEDs, in the present embodiment) (not shown) and is capable of displaying at least one-digit numerical symbols (two-digit numerical characters, in the present embodiment). While the number-of-rounds display device 51 displays “the number of rounds” indicative of the number of rounds which have been played, including the currently-played round game, the present invention is not limited thereto. Namely, the number-of-rounds display device 51 may display the number of rounds from the currently-played round game to the final round game in cases where round games continue as many as possible.

As described above, since there is provided the number-of-rounds display means for displaying the number of rounds during special games, separately from the effect display means for displaying effect images, it is possible to appropriately and clearly display the number of rounds.

Further, since the number-of-rounds display means is provided at the front of the liquid crystal display device 32 which functions as display means for displaying effects relating to the number of rounds, it is possible to display the number of rounds more clearly, with the positional relationship between the display of the number of rounds and the display of the effects.

In the event that a gaming ball enters or passes through the aforementioned starting openings 25 and 44, the regular winning openings 56a to 56d, or the specific region or the normal region of the special winning opening 39, gaming balls are ejected onto the upper plate 20 or the lower plate 22, wherein the number of ejected gaming balls is predetermined on the basis of the types of the respective winning openings.

(Description of Images Displayed on Liquid Crystal Display Device)

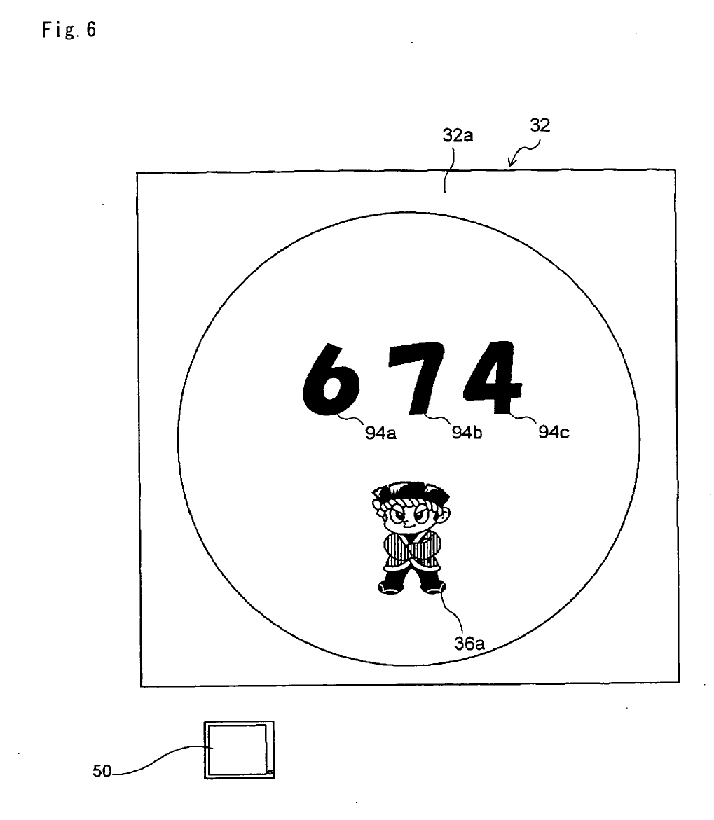

Next, with reference to FIGS. 6 to 8, there will be described effect images including character images and images relating to special symbols, which are displayed on the display region 32a of the liquid crystal display device 32. In FIGS. 6 to 10, for convenience of description, there are illustrated only the liquid crystal display device 32 and the reading device 50, and illustration of the game board 14, the guide rails 30 (30a and 30b) and gaming members such as the obstruction member 55 provided on the game board 14 are omitted.

As illustrated in FIG. 6, on the display region 32a of the liquid crystal display device 32, a character image 36a is displayed and effect identification information 94a, 94b and 94c are statically displayed.

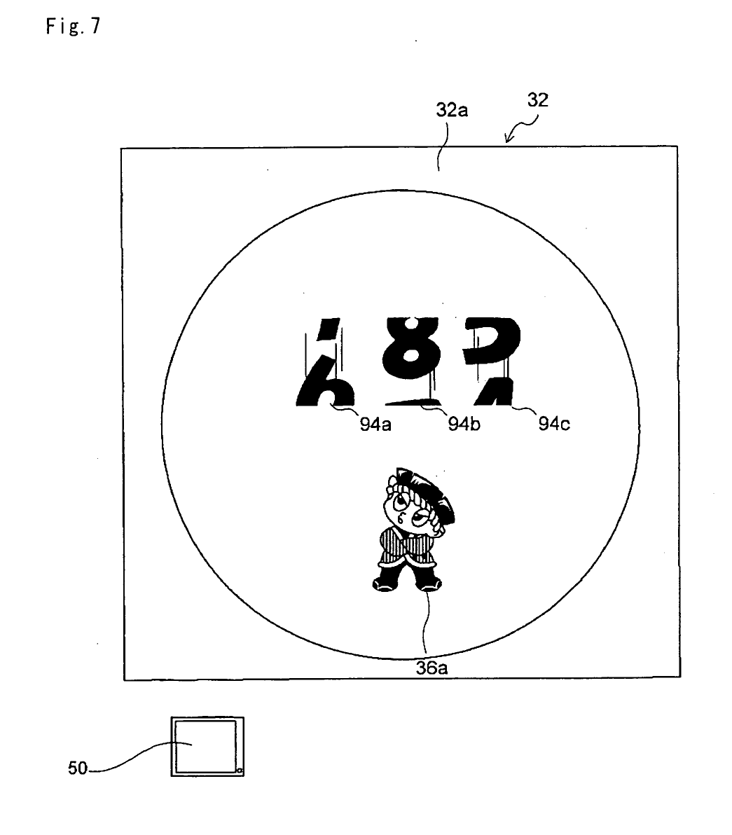

Next, as illustrated in FIG. 7, the effect identification information 94a, 94b and 94c starts to be variably displayed. At this time, the character image 36a is also displayed.

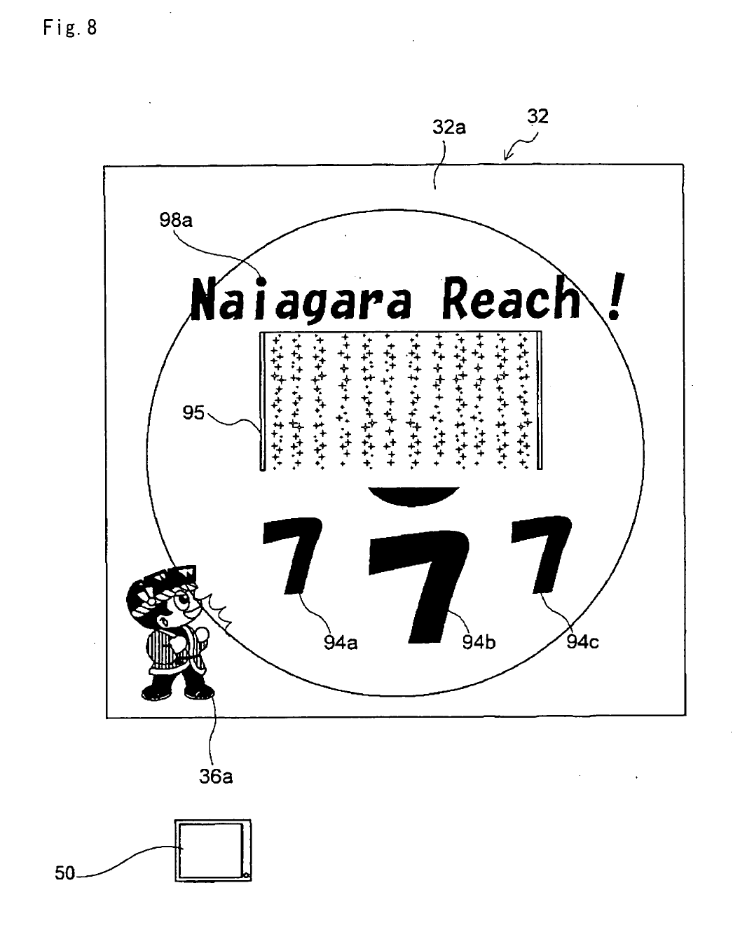

Then, as illustrated in FIG. 8, on the display region 32a of the liquid crystal display device 32, effect identification information is statically displayed in a first stop row (for example, the left row) and a second stop row (for example, the right row), out of the plural symbol rows, wherein the combination of the plural identification information being statically displayed is a predetermined combination and therefore the plural statically-displayed identification information is at a reach state.

More specifically, out of the effect identification information 94a, 94b and 94c, the statically-displayed effect identification information 94a and 94c are both a numerical symbol of “7” and, if a numerical symbol of “7” is statically displayed as the effect identification information 94b in the third stop row (for example, the center row), the combination of the effect identification information 94a, 94b and 94c is brought into a specific display state (for example, numerical symbols of “7” are statically displayed as all the effect identification information 94a, 94b and 94c) and, therefore, the combination of the statically-displayed effect identification information 94a and 94c is brought into a reach state.

In the event of the occurrence of a reach state as illustrated in FIG. 8 (for example, Niagara Reach), a letter image 98a describing “Niagara Reach!” and a character image 36a are displayed on the display region 32a of the liquid crystal display device 32, and further a reach effect image 95 relating to “Niagara Reach” is displayed thereon as an image appearing during a reach state (hereinafter, referred to as a reach effect image).

Since a reach effect image as described above is displayed, it is possible to notify the player that there is the possibility that the combination of the effect identification information 94a, 94b and 94c becomes a specific display state, thereby enhancing the player's interest therein. There are plural reach effect images and, in addition to the reach effect image 95 relating to “Niagara Reach” as illustrated in FIG. 8, a predetermined number (a plural number) of types of reach effect images may be displayed on the display region 32a of the liquid crystal display device 32, as will be described later with reference to FIG. 12.

(Description of Display of Output Information Images)

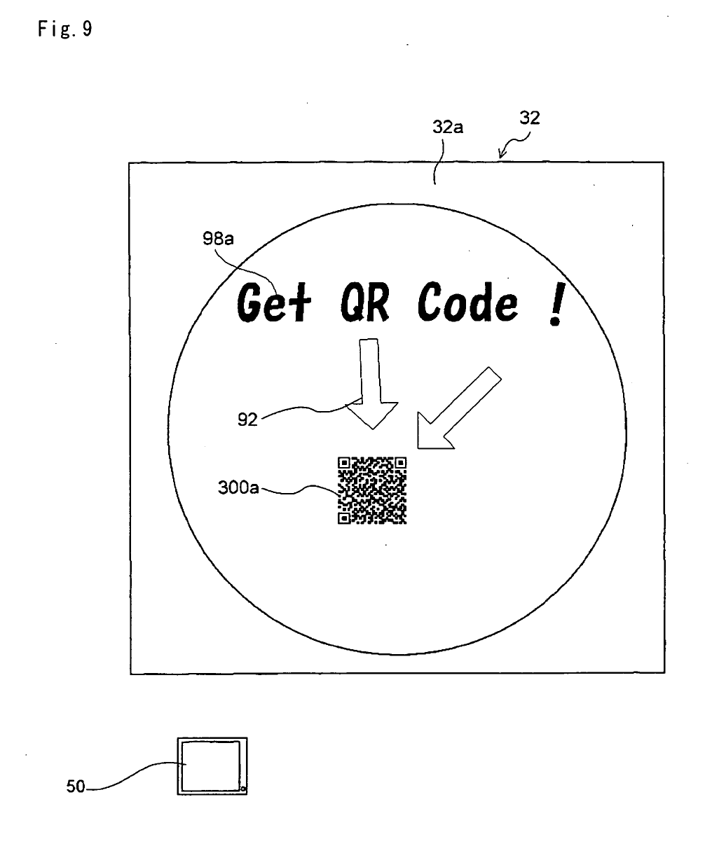

Next, with reference to FIG. 9, there will be described output information images (for example, two-dimensional codes 300a) displayed on the display region 32a of the liquid crystal display device 32. When the reach effect image 95 relating to “Niagara Reach” as described above is displayed, an output information image display notification effect image is displayed on the display region 32a of the liquid crystal display device 32, wherein such an output information image display notification effect image is an image notifying the player that an output information image will be displayed, such as an image describing “Get access code!!, Get ready to capture”.

After a predetermined time has elapsed since the notification effect image is started to be displayed, as illustrated in FIG. 9, a two-dimensional code 300a as an exemplary output information image is displayed on the display region 32a of the liquid crystal display device 32, in such a manner that it can be captured from the outside. The two-dimensional code 300a includes output information associated with one of the predetermined number of types of reach effect images, as will be described later. Namely, when the reach effect image 95 relating to “Niagara Reach” is displayed, for example, a two-dimensional code 300a associated with the reach effect image 95 relating to “Niagara Reach” is displayed on the display region 32a of the liquid crystal display device 32, wherein the two-dimensional code 300a includes output information associated with the reach effect image 95 relating to “Niagara Reach”.

Further, along with the reach effect image, output information image-related effect images are displayed on the display region 32a of the liquid crystal display device 32, wherein such output information image-related effect images include, for example, a letter image 98a describing “Get QR code!” and an image 92 of an arrow. Then, the player can capture the two-dimensional code 300a with the CCD camera 480 (see FIG. 1) of the portable terminal device 400, by operating the portable terminal device 400. When the two-dimensional code 300a is captured by the CCD camera 480 (see FIG. 1) of the portable terminal device 400, image information based on the reach effect image 95 relating to “Niagara Reach” is generated in the portable terminal device 400. The generated image information is included in a two-dimensional code 300b (see FIG. 1) as an output information image and is transmitted to the pachinko gaming machine 10 or transmitted as image information to the server 600, as will be described later.

(Description of Display of Image Information Inputting Images)

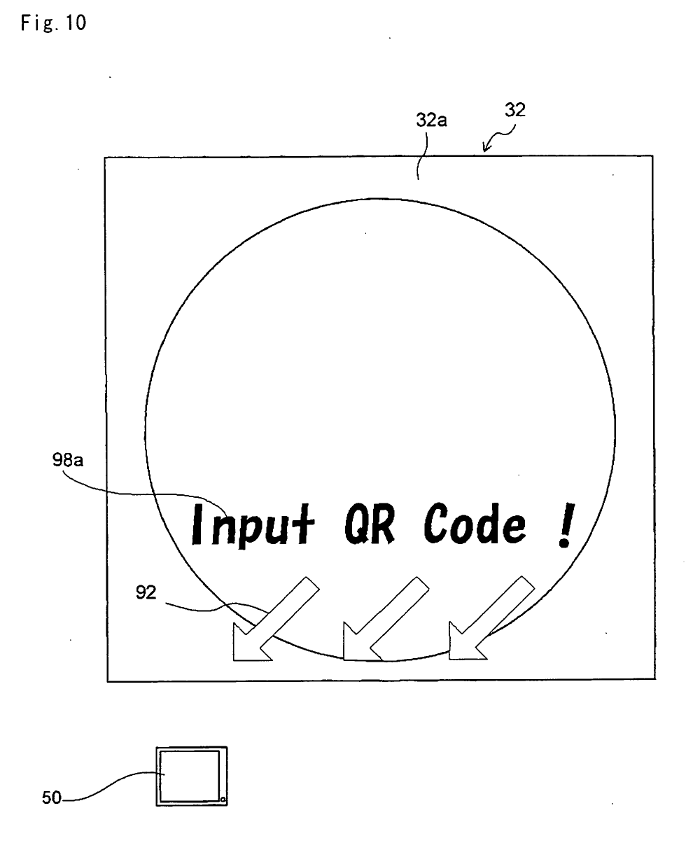

Next, with reference to FIG. 10, there will be described image information transmission display images which are displayed on the display region 32a of the liquid crystal display device 32 when image information generated in the portable terminal device 400 is transmitted to the pachinko gaming machine 10 along with a two-dimensional code. After a reach effect image is displayed as illustrated in FIG. 8 and a two-dimensional code 300a is captured, when a predetermined time has elapsed, image information input instruction images are displayed on the display region 32a of the liquid crystal display device 32, wherein such image information input instruction images include a letter image 98a providing an instruction for inputting of image information, such as an image describing “Input QR code”, an image 92 of an arrow. While these effect images are displayed thereon, if the player operates the operating switch 264, a two-dimensional code as an output information image including the generated image information (for example, a two-dimensional code 300a (see FIG. 1) displayed on the liquid crystal panel 460 (not shown) of the portable terminal device 400) is captured by the reading device 50 of the pachinko gaming machine 10. Namely, the pachinko gaming machine 10 receives the image information from the portable terminal device 400 through the reading device 50. As described above, the reading device 50 functions as exemplary reception means.

Then, on the condition that the image information included in the two-dimensional codes 300b captured by the reading device 500 is image information associated with predetermined types of reach effect images, a predetermined benefit is provided to the player.

Further, as will be described later, the image information generated in the portable terminal device 400 may be transmitted to the server 600 through the Internet 500. The server 600 receives the image information through the communication interface 650 (see FIG. 22) or the like. Namely, the communication interface 650 of the server 600 receives image information associated with reach effect images from the outside. Then, on the condition that the communication interface 650 of the server 600 has received image information associated with predetermined types of reach effect images, the communication interface 650 transmits information (for example, premium data or the like) relating to a predetermined benefit (for example, a special image or music) to the portable terminal device 400, through a communication line.

As described above, two-dimensional codes 300a including output information associated with each of the plural types of reach effect images are captured by the CCD camera 480 of the portable terminal device 400 (from the outside) and, as a result, image data based on the two-dimensional codes 300a is generated. Then, information relating to the resultant image data is received, as image information associated with the reach effect images, from the portable terminal device 400. Then, on the condition that the pachinko gaming machine 10 or the server 600 receives the image information associated with the predetermined types of reach effect images, a predetermined benefit is provided to the player. Namely, in order to provide a predetermined benefit, the following actions should be performed for the predetermined types of reach effect images, which requires the player to make efforts during games. For example, two-dimensional codes 300a associated with the plural types of reach effect images are captured by the CCD camera 480 of the portable terminal device 400 to generate image data and, image information associated with the reach effect images, which is based on the generated image data, is transmitted to the pachinko gaming machine 10 or the server 600 and then the image information is received by the reception means (for example, the reading device 50 of the pachinko gaming machine 10, the communication interface 650 of the server 600). As described above, as a condition for providing predetermined benefits to the player, the player is required to make efforts during games, which provides a new game aspect to the player, thereby enhancing his or her interest in games.

Further, in the pachinko gaming machine 10, a control for displaying output information image-related effect images such as a letter image 98a and an image 92 (see FIG. 9) around the two-dimensional code 300a displayed on the display region 32a of the liquid crystal display device 32 is conducted for emphasizing the two-dimensional code 300a displayed thereon. Accordingly, the player can easily recognize that the two-dimensional code 300a is displayed as a result of the player's ability to play games and, therefore, the player can find greater satisfaction in the acquisition of the output information image.

Also, while in the present embodiment the liquid crystal display device 32 constituted by a liquid crystal display panel is employed as a portion for displaying images, the present invention is not limited thereto and may employ other types of displaying portions, such as a Braun tube including a CRT (Cathode Ray Tube), dot LEDs, segment LEDs, ELs (Electronic Luminescents), plasma or the like. Further, while, in the present embodiment, there has been described a case where the liquid crystal display device 32 is provided substantially at the center of the front surface of the gaming board 14 of the pachinko gaming machine 10 as a gaming machine, the liquid crystal display device 32 may be provided at any position which can be viewed from the player. Also, while, in the present embodiment, the special symbol display device 33 and the normal symbol display device 34 are provided in addition to the liquid crystal display device 32, the present invention is not limited thereto and the liquid crystal display device 32 may be configured to variably display special symbols and normal symbols. Further, while the liquid crystal display device 32 is employed as a variable display means, the present invention is not limited thereto and may employ other types of variable display means, such as a drum, a belt, a leaf and the like.

(Description of Two-Dimensional Codes)

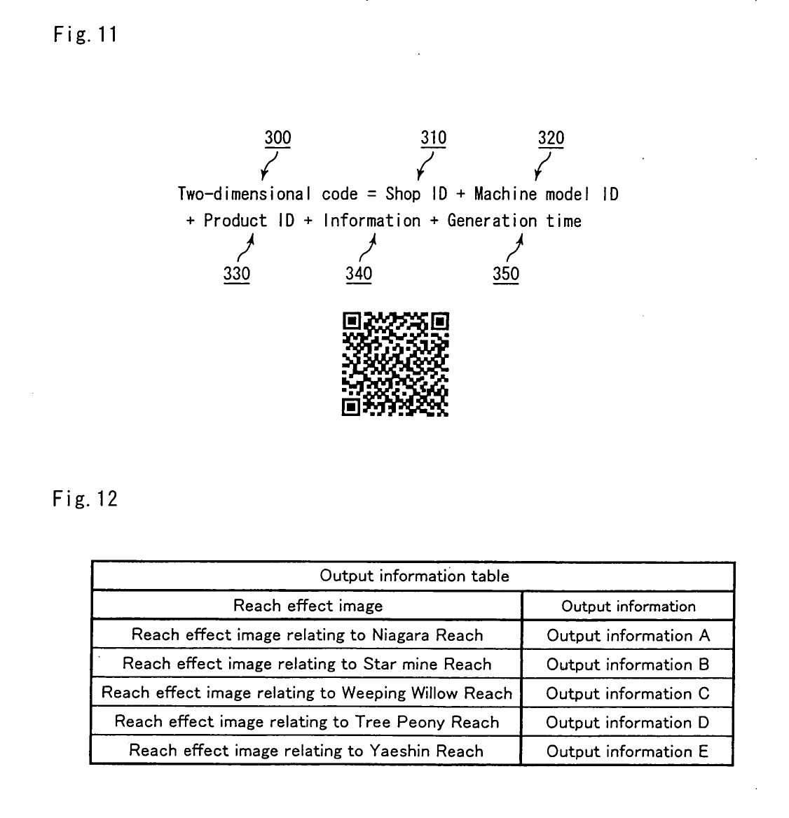

With reference to FIG. 11, there will be described output information images displayed on the liquid crystal display device 32, according to the present embodiment. FIG. 11 is an explanation view illustrating an output information image which is displayed in the pachinko gaming machine according to the present embodiment.

The output information image according to the present embodiment is a two-dimensional code 300 as illustrated in FIG. 11 and includes, as information, a shop ID 310, a machine model ID 320, a product ID 330, information 340 and a generation time 350. The two-dimensional code can include a greater amount of information than conventional barcodes. The shop ID 310 is an ID indicative of the game arcade in which the pachinko gaming machine 10 is installed. The machine model ID 320 is an ID indicative of the machine model of the pachinko gaming machine 10. The product ID 330 is an ID indicative of the production number of the pachinko gaming machine 10. The information 340 is predetermined information such as output information (the detail thereof will be described later). The generation time 350 indicates the time when the output information image was generated.

The output information image according to the present embodiment includes code counterfeiting prevention means such as the shop ID 310, the machine model ID 320, the product ID 330 and the generation time 350. Accordingly, the output information image indicates the game arcade, the machine model, the production number and the time where and when the output information image was generated, which can prevent the counterfeiting of the output information image.

FIG. 12 illustrates an exemplary output information table storing plural information 340, which is stored in a program ROM 208 (see FIG. 13) which will be described later. As illustrated in FIG. 12, the output information table stores the types of reach effect images and output information as information 340, in association with each other. For example, a reach effect image relating to “Niagara Reach” and output information A are stored in association with each other. In addition, a reach effect image relating to “Starmine Reach” and output information B, a reach effect image relating to “Weeping Willow Reach” and output information C, a reach effect image relating to “Tree Peony Reach” and output information D, and a reach effect image relating to “Yaeshin Reach” and output information E are stored in associated with each other.

Namely, when Niagara Reach is selected as a type of reach and the reach effect image relating to “Niagara Reach” is displayed, the output information A, as output information included in a two-dimensional code 300a, is transmitted from the pachinko gaming machine 10 to the portable terminal device 400. Also, when Starmine Reach is selected as a type of reach and the reach effect image relating to “Starmine Reach” is displayed, the output information B, as output information, is transmitted from the pachinko gaming machine 10 to the portable terminal device 400. Also, when Weeping Willow Reach is selected as a type of reach and the reach effect image relating to “Weeping Willow Reach” is displayed, the output information C, as output information, is transmitted from the pachinko gaming machine 10 to the portable terminal device 400. Also, when Tree Peony Reach is selected as a type of reach and the reach effect image relating to “Tree Peony Reach” is displayed, the output information D, as output information, is transmitted from the pachinko gaming machine 10 to the portable terminal device 400. Also, when Yaeshin Reach is selected as a type of reach and the reach effect image relating to “Yaeshin Reach” is displayed, the output information E, as output information, is transmitted from the pachinko gaming machine 10 to the portable terminal device 400.

While, in the present embodiment, the output information as the information 340 is information (data) indicative of different reach effect images, the present invention is not limited thereto. The output information may be arguments consisting of numerical characters and the like, arguments consisting of alphanumeric characters and the like, IDs, or passwords. Also, the output information may be URLs of special websites, image data for waiting images, music data for cellular phone ring melodies. Further, the information 340 may be service points or game information. Also, the information 340 may be various types of programs such as games.

Also, while in the present embodiment, the information 340 is output information for acquiring premium data (for example, service points or game information), the information 340 may be a portion of image data for a waiting image, a portion of music data for a cellular phone ring melody or a portions of one of various types of programs such as games. In this case, two-dimensional codes 300a including such information can be captured by the portable terminal device 400 and then can be combined to one another to acquire an cellular phone ring melody, an image as a waiting image, or one of various types of programs such as games. Accordingly, the present invention may provide a system having a gaming machine and an external terminal device, wherein the gaming machine includes display means for displaying plural types of images including plural types of reach effect images which are displayed until the execution of special games advantageous to a player and display control means for conducting a control for displaying any types of output information images, out of plural types of output information images including output information associated with the respective plural types of reach effect images, in such a manner that the output information images can be captured with image pickup means from the outside, the external terminal device includes the aforementioned image pickup means, and the aforementioned external terminal device can capture predetermined types of output information images, out of the plural types of output information images including output information associated with the respective reach effect images, with the image pickup means, from the outside, to acquire a predetermined benefit.

Accordingly, in the present system, out of plural types of output information images displayed on the display means (liquid crystal display 32), predetermined types of output information images are captured by external terminal device, whereby the predetermined benefit (for example, a completed waiting image, a completed cellular phone ring melody, data of a game) is provided to the player. Accordingly, with the present system, it is possible to provide, to players, a new game aspect which enables the players to capture a predetermined combination of any types of output information images, thereby enhancing their interest in games.

Further, while, in the present embodiment, two-dimensional codes are realized by employing specifications such as QR codes (registered trademark), the present invention is not limited to two-dimensional codes (registered trademark) and may employ other specifications such as DataMatrix (registered trademark).

(Electric Structure of Gaming Machine)

With reference to FIG. 13, a control circuit of the pachinko gaming machine 10 according to the present embodiment will be described. FIG. 13 is a block diagram illustrating a control circuit of the pachinko gaming machine 10 according to the present embodiment.

As illustrated in FIG. 7, a main control circuit 60 as game control means includes a main CPU 66 as a controlling means, a main ROM (Read Only Memory) 68, and a main RAM (Read Access Memory) 70. The main control circuit 60 controls the progress of games.

The main ROM 68, the main RAM 70 and the like are connected to the main CPU 66 and, the main CPU 66 has the function of performing various types of processes in accordance with programs stored in the main ROM 68. As described above, the main CPU 66 functions as various means as will be described later, such as special game execution means and lottery means.

The main ROM 68 stores programs for controlling the operations of the pachinko gaming machine 10 with the main CPU 66 and also stores various types of tables such as a big-hit determination table which is referred to in performing big-hit determination through random number lottery, a effect condition selecting table which is referred to when effect is selected and like that, and output information image display constant number.

The main RAM 70 has the function of storing various flags and variable values, as a temporal storage region of the main CPU 66. As specific examples of data stored in the main RAM 70, there is data as follows.

In the main RAM 70, there are positioned a control state flag, a specific region passage flag, a big-hit determination random number counter, a big-hit symbol determination random number counter, a failure symbol determination random number counter, an effect condition selection random number counter, a number-of-special-winning-opening-opens counter, a special winning opening entry counter, a number-of-rounds display counter, a number-of-rounds display device effect starting counter, a waiting time timer, a special winning opening open time timer, data indicative of the number of holds relating to special symbols, data indicative of the number of holds relating to normal symbols, data for transmitting commands to a sub control circuit 20 which will be described later, variables and the like.

The control state flag indicates the control state for special symbols. The specific region passage flag is used for determining whether or not gaming balls have passed through the specific region.

The big-hit determination random number counter is used for determining whether or not a special symbol big hit should be occurred. The big-hit symbol determination random number counter is used for determining a special symbol to be statically displayed, if it is determined that a special symbol big hit should be occurred. The failure symbol determination random number counter is used for determining a special symbol to be statically displayed, if it is not determined that a special symbol big hit should be occurred. The effect condition selection random number counter is for determining an effect variation pattern. A number-of-rounds display device effect starting counter is used for determining whether or not the display on the number-of-rounds display device is implemented. These counters are updated by the main CPU 66 such that their stored values are incremented one by one, and random numbers are sampled from the respective counters at predetermined timings to execute various functions of the main CPU 66. While, in the present embodiment, these random counters are provided and the main CPU 66 is configured to update these random counters such that their stored values are incremented one by one, in accordance with programs, the present invention is not limited thereto and there may be provided a separate random number generation circuit.

The waiting time timer is provided for synchronization between processes conducted by the main control circuit 60 and the sub control circuit 200. Further, the special winning opening open time timer is for measuring the time during which the shutter 40 is driven to keep the special winning opening 39 opened. Further, while in the present embodiment the timers are updated at predetermined intervals, in the main RAM 70, such that their count values are subtracted by the predetermined interval, the present invention is not limited thereto and the CPU and the like may include timers.

The number-of-special-winning-opening-opens counter indicates the number of times the special winning opening has been opened during a big-hit game state (so-called, the number of rounds). Further, the special winning opening entry counter indicates the number of gaming balls which have entered the special winning opening and passed through the V-counting sensor 102 or the counting sensor 104 during a single round. The data indicative of the number of holds relating to special symbols indicates the number of times a special symbol game has been held, since even if a gaming ball enters the starting opening 25 or 44, the start of a special symbol game is held when variable displaying of special symbols can not be executed. Further, the data indicative of the number of holds relating to normal symbols indicates the number of times a normal symbol game has been held, since even if a gaming ball passes through the passage gate 54a or 54b, the start of a normal symbol game is held when variable displaying of normal symbols can not be executed. The number-of-rounds display counter indicates the number of rounds to be displayed on the number-of-rounds display device 51.

Further, the main control circuit 60 includes a reset clock pulse generation circuit 62 for generating clock pulses with a predetermined frequency, an initial reset circuit 64 for generating a reset signal at power-up, and a serial communication IC 72 for transmitting commands to the sub control circuit 200 which will be described later. The reset clock pulse generation circuit 62, the initial reset circuit 64 and the serial communication IC 72 are connected to the main CPU 66. Further, the reset clock pulse generation circuit 62 generates clock pulses at predetermined intervals (for example, at 2-miliseconds intervals), in order to conduct a system timer interruption process which will be described later.

Further, to the main control circuit 60, there are connected various types of devices such as the V-counting sensor 102, the counting sensor 104, regular winning ball sensors 106, 108, 110 and 112, passed-ball sensors 114 and 115, starting winning ball sensors 116 and 117, a normal electric combination member solenoid 118, a special winning opening solenoid 120, a seesaw solenoid 122, a backup clearing switch 124, as illustrated in FIG. 13.

The V-counting sensor 102 is provided in the specific region of the special winning opening 39. In the event that a gaming ball passes through the specific region of the special winning opening 39, the V-counting sensor 102 transmits a predetermined detection signal to the main control circuit 60.

The counting sensor 104 is provided in the normal region of the special winning opening 39 which is different from the specific region. In the event that a gaming ball passes through the normal region of the special winning opening 39, the counting sensor 104 transmits a predetermined detection signal to the main control circuit 60.

The regular winning ball sensors 106, 108, 110 and 112 are provided in the regular winning openings 56a to 56d, respectively. In the event that a gaming gall passes through the normal winning openings 56a to 56d, the regular winning ball sensors 106, 108, 110 and 112 transmit a predetermined detection signal to the main control circuit 60.

The passed-ball sensors 114 and 115 are provided in the passage gates 54a and 54b, respectively. In the event that a gaming ball passes through the passage gate 54a or 54b, the passed-ball sensor 114 or 115 transmits a predetermined detection signal to the main control circuit 60.

The starting winning ball sensors 116 and 117 are provided in the starting openings 25 and 44, respectively. In the event that a gaming ball enters the starting opening 25 or 44, the starting winning ball sensor 116 or 117 transmits a predetermined detection signal to the main control circuit 60.

The normal electric combination member solenoid 118 is connected to the blade members 48 through a link member (not shown) and brings the blade members 48 into the opened state or the closed state, in response to driving signals transmitted from the main CPU 66.

The special winning opening solenoid 120 is connected to the shutter 40 illustrated in FIG. 5 and drives the shutter 40 to open or close the special winning opening, in response to driving signals transmitted from the main CPU 66.

The seesaw solenoid 122 is connected to a plate-shaped seesaw (not shown) provided inside the shutter 40 and moves the seesaw to change the inclination of the seesaw, in response to driving signals transmitted from the main CPU 66. By inclining the seesaw, the seesaw is switched between a state which allows gaming balls to easily pass through the specific region and a state which allows gaming balls to easily pass through the normal region.

The backup clearing switch 124 is incorporated in the pachinko gaming machine 10 and has the function of clearing data which was backed up at power-off and the like, in accordance with operations of an administrator of the game arcade.

The disbursement/launching control circuit 126 is connected to the main control circuit 60. A disbursement device 128 for disbursing gaming balls, a launching device 130 used for launching gaming balls and a card unit 150 are connected to the disbursement/launching control circuit 126.

The disbursement/launching control circuit 126 receives ball winning control commands transmitted from the main control circuit 60 and ball rental control signals transmitted from the cart unit 150 and transmits predetermined signals to the disbursement device 128 to cause the disbursement device 128 to disburse gaming balls. Further, the disbursement/launching control circuit 126 transmits launching signals to the launching device 130 for controlling it to launch gaming balls.

The launching device 130 includes devices for launching gaming balls, such as the aforementioned launching solenoid, the touch sensor and the like. When the player grasps the launching handle 26 and rotates it in the clockwise direction, the launching solenoid is fed with electric power according to the angle of rotation to successively launch gaming balls stored on the upper plate 20 towards the gaming board 14.

A lamp controller circuit 76 for controlling lamps 74 is connected to the main control circuit 60, and the lamps 74 are connected to the lamp controller circuit 76. The lamp controller circuit 76 transmits lamp (LED) controlling signals to the lamps 74. The lamps 74 include incandescent lamps, LEDs and the like and more specifically include the special symbol hold lamps 34a to 34d, the normal symbol hold lamps 50a to 50d, the special symbol display device 33 (7-segment LEDs 41), the normal symbol display device 35 (displaying lamps), the number-of-rounds display device 51 (7-segment LEDs 52) and the like.

On the other hand, the sub control circuit 200 is connected to the serial communication IC 72. The sub control circuit 200 controls the display on the liquid crystal display device 32, sound to be generated from a speaker 46, lamps 74, lamps 132, in response to various commands transmitted from the main control circuit 60. The lamps 132 include incandescent lamps, LEDs and the like and, more specifically, include decoration lamps (not shown) for displaying the gaming board 14 in a dark and bright manner.

While, in the present embodiment, the main control circuit 60 transmits commands to the sub control circuit 200 while the sub control circuit 200 is not capable of transmitting signals to the main control circuit 60, the present invention is not limited thereto and the sub control circuit 200 may be configured to be capable of transmitting signals to the main control circuit 60.

The sub control circuit 200 includes a sub CPU 206, a program ROM 208 as storage means, a work RAM 210, a display control circuit 250 as display control means for controlling the display on the liquid crystal display device 32, a sound control circuit 230 for controlling sound to be generated from the speaker 46. The sub control circuit 200 executes effects in accordance with the progress of games, in response to commands from the main control circuit 60. Further, as will be described later, the sub control circuit 200 may execute effects as benefits, in accordance with image information received by the reading device 50 as reception means.

The program ROM 208, the work RAM 210 and the like are connected to the sub CPU 206. The sub CPU 206 has the function of executing various types of processes, in accordance with programs stored in the program ROM 208. Particularly, the sub CPU 206 controls the sub control circuit 200, in accordance with various commands transmitted from the main control circuit 60. The sub CPU 206 functions as various means as will be described later.

The program ROM 208 stores programs for controlling game effects in the pachinko gaming machine 10 on the sub CPU 206 and also stores various types of tables such as a table used for making determinations relating to effects, an output information image display notification effect pattern, an output information image display timer, an output information image-related information pattern, output information image patterns, the shop ID 310, the machine model ID 320, and the product ID 330. The output information image patterns are patterns of output information images associated with image data for waiting images, music data for cellular phone ring melodies, URL data, various types of programs and the like.

Further, the program ROM 208 stores plural types of effect patterns. The effect patterns relate to the progress of effect displaying which is executed in association with variable displaying of special symbols. In addition, the program ROM 208 stores plural types of effect patterns used during playing of special games. The effect patterns used during playing of special games relate to the progress of effect displaying which is executed in association with round games during special games The program ROM 208 further stores the output information image display timer for setting the time until an output information image and like that is displayed after an output information image display notification effect.

While, in the present embodiment, the main control circuit 60 is configured to utilize the main ROM 68 and the sub control circuit 200 is configured to utilize the program ROM 208 as storage means for storing programs, tables and the like, the present invention is not limited thereto and may employ any other types of storage media which are readable by computers including control means and, for example, such programs, tables and the like may be stored in a storage medium such as a hard disk device, a CD-ROM, a DVD-ROM, a ROM cartridge and the like. As a matter of cause, the main ROM 68 may be utilized instead of the program ROM 208. Also, these programs may be downloaded after power-up and then recorded in the main RAM 70 in the main control circuit 60 and in the work RAM 210 or the like in the sub control circuit 200, rather than be pre-recorded. Also, the respective programs may be recorded in different recording media.

The work RAM 210 has the function of storing various flags and variable values, as a temporal storage region of the sub CPU 206. For example, there are positioned, therein, an effect display selection random number counter used for selecting effect patterns, various types of variable values and the like.

Further, while, in the present embodiment, the main RAM 70 is utilized as a temporal storage region of the main CPU 66 and the work RAM 210 is utilized as a temporal storage region of the sub CPU 206, the present invention is not limited thereto and may employ any read-and-write storage media.

The display control circuit 250 functions as a display control means and is constituted by an image data processor (hereinafter, referred to as a VDP) 212, an image data ROM 216 for storing various types of image data, a D/A converter 218 for converting image data into image signals, and an initial reset circuit 220 for generating a reset signal at power-up.

The aforementioned VDP 212 is connected to the sub CPU 206, the image data ROM 216, the D/A converter 218, and the initial reset circuit 220.

The VDP 212 is a device including circuits such as a so-called sprite circuit, a screen circuit, a palette circuit and capable of performing various processes for displaying images on the liquid crystal display device 32. Namely, the VDP 212 controls the display on the liquid crystal display device 32. Further, the VDP 212 includes a memory 269 (for example, a video RAM) as a buffer used for displaying images on the display region 32a of the liquid crystal display device 32. By storing image data in a predetermined storage region of the storage medium, an image is displayed on the display region 32a of the liquid crystal display device 32 at predetermined timing.

The image data ROM 216 separately stores various types of image data, such as effect identification information image data indicative of effect identification information, background image data, effect image data including output information images, and the like. As a matter of course, it further stores related-image data indicative of relating images.

The VDP 212 reads, from the image data ROM 216, various types of image data such as effect identification information image data, background image data, effect image data, and the like in response to image displaying commands sent from the sub CPU 206, and generates image data to be displayed on the liquid crystal display device 32. The VDP 212 superimposes the generated image data on one another in order from image data to be placed at a rearmost position, then stores them in the memory 269 and then sends it to the D/A converter 218 at predetermined timing. The D/A converter 218 converts the image data into image signals and sends the image signals to the liquid crystal display device 32 to cause an image to be displayed on the liquid crystal display device 32.

Further, the sound control circuit 230 is constituted by a sound source IC 232 for performing control relating to sound, an audio data ROM 234 for storing various types of sound data, and an amplifier 236 for amplifying sound signals (hereinafter, referred to as an AMP).

The sound source IC 232 is connected to the sub CPU 206, the initial reset circuit 220, the audio data ROM 234 and the AMP 236. The sound source IC 232 controls sound to be generated from the speaker 46.

The reading device 50 includes a CCD camera 266 for capturing a two-dimensional code 300b (see FIG. 1) displayed on the liquid crystal panel 460 of the portable terminal device 400, an image processing circuit 268 for executing various types of processes on image data obtained by capturing the two-dimensional code 300b through the CCD camera 266, a memory 269 for temporarily storing the image data (image information) obtained by capturing the two-dimensional code 300b through the CCD camera 266, and a reading device control circuit 262 including a CPU (not shown) for controlling the operations of the CCD camera 266 and the image processing circuit 268 on receiving reading command signals from the operating switch 264.

Herein, the structure of the reading device 50 is not limited to the aforementioned example and it is possible to employ any conventionally-known devices capable of reading image information such as two-dimensional codes 300b.

(Operation of the Gaming Machine)

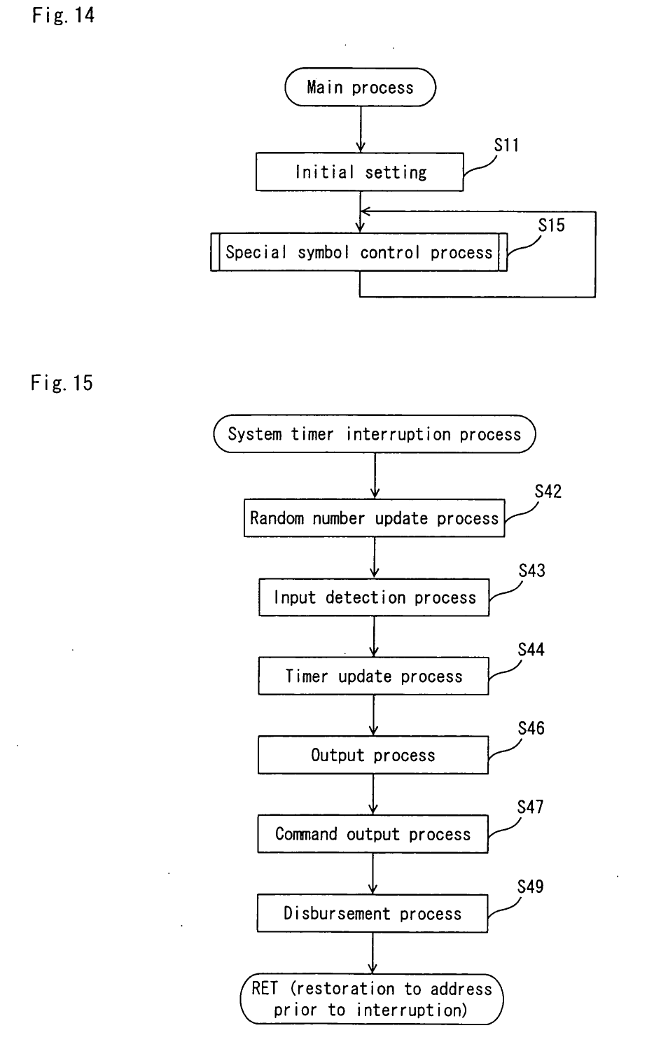

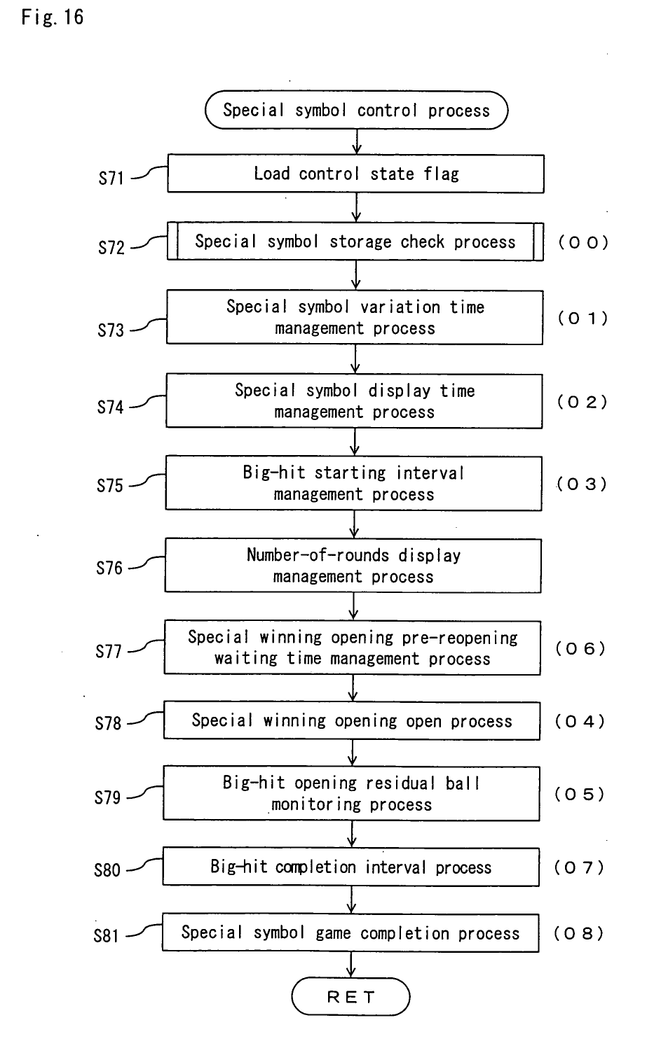

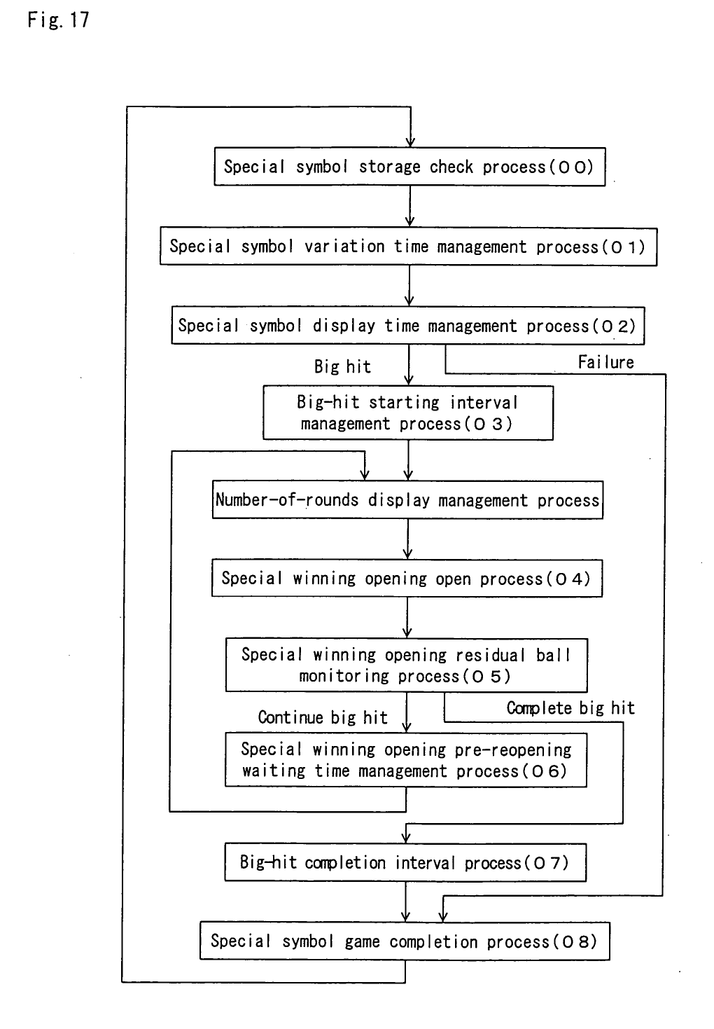

Hereinafter, FIGS. 14 to 19 illustrate a process which is conducted in the pachinko gaming machine 10. Further, with reference to FIG. 17, there will be described state transitions during special symbol control process (FIG. 16) conducted in the gaming machine 10.

(Main Process)

First, as illustrated in FIG. 14, an initial setting process is conducted (step S11), wherein the initial setting process includes RAM access permission, backup restoration, initialization of work areas, initial setting of a special game total executing time timer, a number-of-special-games counter and the like. Then, as will be described in detail later with reference to FIG. 16, a special symbol control process relating to the progress of special symbol games, special symbols on the special symbol display device 33 and effect identification information displayed on the liquid crystal display device 32 is conducted (step S15). As described above, in the main process, after the completion of the initial setting process in step S11, the process in step S15 is repeatedly conducted.

(System Timer Interruption Process)

Further, even when the main CPU 66 is executing the main process, the main CPU 66 may interrupt the main process and conduct a system timer interruption process. In response to clock pulses which are generated from the reset clock pulse generation circuit 62 at predetermined intervals (for example, at 2-milisecond intervals), the main CPU 66 conducts the following system timer interruption process. The system timer interruption process will be described with reference to FIG. 9.

First, as illustrated in FIG. 15, the main CPU 66 conducts a random number update process for incrementing, by “1”, the respective counter values of the big-hit determination random number counter, the big-hit symbol determination random number counter, a number-of-rounds display device effect selecting counter and the like (step S42). Then, the main CPU 66 conducts an input detection process for detecting gaming balls entering or passing through the starting openings 25 or 44 or the like (step S43). Then, the main CPU 66 conducts a process for updating various types of timers, such as the waiting time timer used for synchronization between the main control circuit 60 and the sub control circuit 200, the special winning opening open time timer for measuring the time during which the special winning opening 39 has been opened, wherein the special winning opening 39 is opened in the event of the occurrence of a big hit (step S44). Then, the main CPU 66 conducts an output process, in order to transmit, to solenoids, a motor and the like, signals for driving and controlling them on the basis of various types of variable values (step S46). After the completion of this process, the process proceeds to step S47.

In step S47, command output process is conducted. In this process, the main CPU 66 transmits various types of commands to the sub control circuit 200. Specifically, these various types of commands include demonstration displaying commands, effect stop symbol designation commands indicative of the types of effect identification information to be statically displayed in the left row, the center row and the right row, variation pattern designation commands indicative of variation patterns of effect identification information, output information image displaying commands and the like. After the completion of the process, the process proceeds to step S49.

Then, in step S49, the main CPU 66 conducts a disbursement process for transmitting ball winning control commands for causing the disbursement device 128 to disburse balls, to the disbursement/launching control circuit 126. Further, the main CPU 66 transmits, to the disbursement/launching control circuit 126, ball winning control commands for causing it to disburse a predetermined number of balls, in the event of entry of a gaming ball into the various types of winning openings. After the completion of the process, this subroutine ends and main CPU 66 is restored to an address at which it existed prior to the occurrence of the interruption and conducts the main process.

(Special Symbol Control Process)

With reference to FIG. 16, the subroutine conducted in step S15 of FIG. 14 will be described. In FIG. 16, the numerical values represented at the sides of steps S72 to S82 indicate the numerical values of the control state flag corresponding to the respective steps and, on the basis of the current numerical value of the control state flag, a single step corresponding to the numerical value is conducted to progress special symbol games.

First, as illustrated in FIG. 16, a process for loading the control state flag is conducted (step S71). In this process, the main CPU 66 reads the control state flag. After the completion of this process, the process proceeds to step S72.

Further, in steps S72 to S82 which will be described later, on the basis of the value of the control state flag, the main CPU 66 determines whether or not various types of processes at the respective steps should be conducted. The control state flag indicates the game state of special symbol games and allows one of the processes in steps S72 to S82 to be conducted. In addition thereto, the main CPU 66 conducts the process at the respective steps at predetermined timing based on the waiting time timer, wherein the predetermined timing is set for the respective steps. Further, prior to the predetermined timing, the subroutine ends without conducting the process at the respective steps and another subroutine is conducted. As a matter of cause, the system timer interruption process is conducted at predetermined intervals.

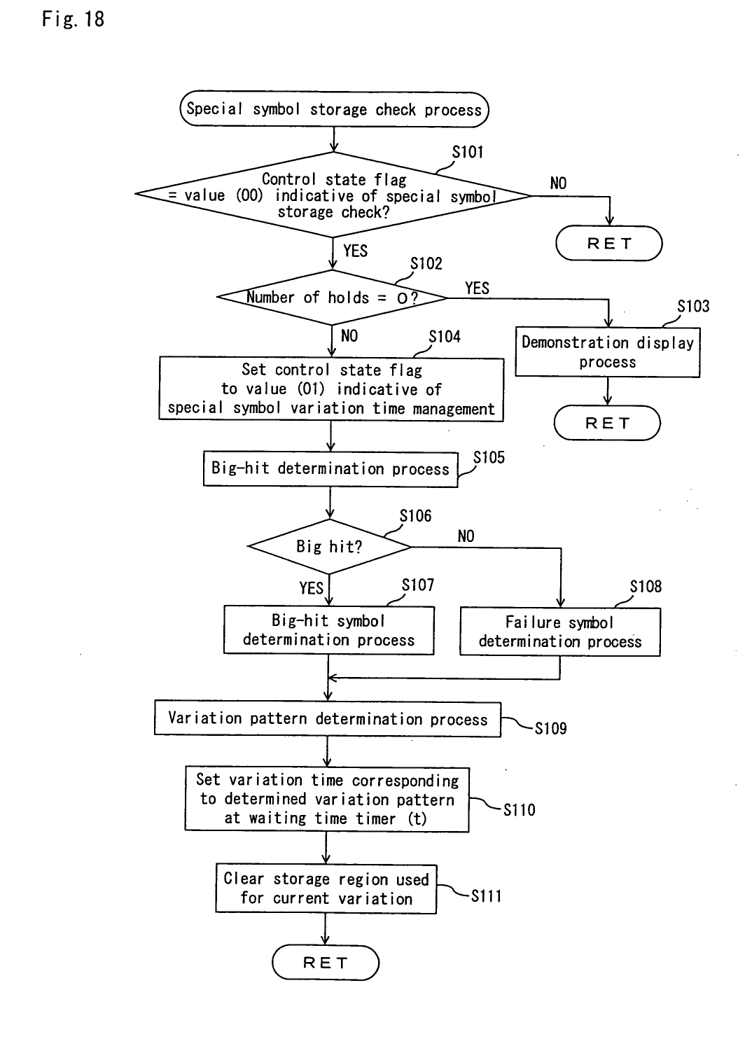

In step S72, special symbol storage check process is conducted. The detail thereof will be described later with reference to FIG. 18. After the completion of this process, the subroutine proceeds to the process in step S73.

In step S73, a special symbol variation management process is conducted. In the process, the control state flag has a value (01) indicative of special symbol variation time management and, after the elapse of a variation time, the main CPU 66 sets the control state flag to a value (02) indicative of special symbol display time management and also sets the waiting time timer to a post-determination waiting time (for example, one second). Namely, the process in step S74 is set to be conducted after the elapse of the post-determination waiting time. At the completion of this process, the subroutine proceeds to the process in step S74.

In step S74, a special symbol display time management process is conducted. In this process, the control state flag has the value (02) indicative of special symbol display time management and, after the elapse of the post-determination waiting time, the main CPU 66 determines whether or not a big hit occurs. If a big hit occurs, the main CPU 66 sets the control state flag to a value (03) indicative of big-hit starting interval management and also sets the waiting time timer to a time corresponding to a big-hit starting interval (for example, 10 seconds). Namely, the process in step S75 is set to be conducted, after the elapse of the time corresponding to the big-hit starting interval. On the other hand, if a big hit does not occur, the main CPU 66 sets the control state flag to a value (08) indicative of the completion of special symbol games. Namely, the process in step S81 is set to be conducted. After the completion of this process, the subroutine proceeds to the process in step S75.

In step S75, a big-hit starting interval management process is conducted. In this process, the control state flag has a value (03) indicative of big-hit starting interval management and, after the elapse of a time corresponding to the big-hit starting interval, the main CPU 66 stores, in the main RAM 70, data for opening the special winning opening 39, which has been read from the main ROM 68. Then, the main CPU 66 reads data for opening the special winning opening 39, which has been stored in the main RAM 70 in step S46 in FIG. 15, and transmits a signal commanding for opening the special winning opening 39 to the special winning opening solenoid 120. As described above, the main CPU 66 controls the opening/closing of the special winning opening 39. Namely, a special game in which a round game can be repeatedly executed in plural times is executed, wherein a predetermined advantageous game state (a game state which starts with an opened state where gaming balls can easily enter the special winning opening 39 and ends with a closed state where gaming balls can not easily enter the special winning opening 39) is offered in the round game.

Further, the main CPU 66 sets the control state flag to a value (04) indicating that the special winning opening is being opened and also sets the special winning opening open time timer to an opening upper limit time (for example, 30 seconds). Namely, the main CPU 66 sets the configuration such that the process in step S78 is conducted. As described above, the main CPU 66 is exemplary special game execution means for executing special games. Further, the main CPU 66 substitutes a predetermined number (for example, “15”) into the number-of-rounds display counter in the main RAM 70. Further, the main CPU 66 starts to measure the special game execution time using the special game execution time timer within the main RAM 70. After the completion of this process, the subroutine proceeds to the process in step S76.

In step S76, a number-of-rounds display management process is conducted. In this process, the main CPU 66 selects a single number-of-rounds displaying pattern from plural number-of-rounds displaying patterns stored in the main ROM 68, on the basis of the number substituted in the number-of-rounds display counter stored in a predetermined region of the main RAM 70, and stores the selected number-of-rounds displaying pattern in a predetermined region of the main RAM 70.

Further, the data indicative of the number-of-rounds displaying pattern stored in the predetermined region of the main RAM 70 is transmitted to the lamp controller circuit 76, as a signal for controlling the display on the number-of-rounds display device 51 (a number-of-rounds display controlling signal), through the process in step S46 in FIG. 15. On receiving the number-of-rounds display controlling signal, the lamp controller circuit 76 controls displaying on the number-of-rounds display device 51, on the basis of the number-of-rounds display controlling signal. As described above, the lamp control circuit 76 is exemplary main control means for controlling the display of the number of rounds during special games, on the number-of-rounds display means. After the completion of this process, the subroutine proceeds to the process in step S77.

In step S77, a special winning opening pre-reopening waiting time management process is conducted. In this process, the control state flag has a value (06) indicative of special winning opening pre-reopening waiting time management and, after the elapse of a time corresponding to the inter-round interval, the main CPU 66 updates the number-of-special-winning-opening-opens counter such that the stored value is incremented by “1”. The main CPU 66 sets the control state flag to a value (04) indicating that the special winning opening is being opened. The main CPU 66 sets the special winning opening open time timer to an opening upper limit time (for example, 30 seconds). Namely, the main CPU 66 sets the configuration such that the process in step S78 is conducted. After the completion of this process, the subroutine proceeds to the process in step S78.

In step S78, a special winning opening open process is conducted. In this process, in the case where the control state flag has the value (04) indicating that the special winning opening is being opened, the main CPU 66 determines whether or not either the condition that the special winning opening entry counter is equal to or greater than “10” or the condition that the opening upper limit time has elapsed (the special winning opening open time timer is “0”) is satisfied. If any of the conditions is satisfied, the main CPU 66 updates the variable values positioned in the main RAM 70, in order to close the special winning opening 39. The main CPU 66 sets the control state flag to a value (05) indicative of monitoring of residual balls within the special winning opening. The main CPU 66 sets the waiting time timer to a special winning opening residual ball monitoring time (for example, 1 second). Namely, the main CPU 66 sets the configuration such that the process in step S79 is conducted after the elapse of the special winning opening residual ball monitoring time. Further, if either condition is not satisfied, the main CPU 66 does not conduct the aforementioned process. After the completion of this process, the subroutine proceeds to the process in step S79.

In step S79, a special winning opening residual ball monitoring process is conducted. In this process, the control state flag has the value (05) indicative of monitoring of residual balls within the special winning opening and, after the elapse of the special winning opening residual ball monitoring time, the main CPU 66 determines whether or not the condition that no gaming ball has passed through the specific region of the special winning opening 39 or the condition that the number-of-special-winning-opening-opens counter is equal to or greater than “2” (in the case where a specific numerical symbol of “3” was statically displayed on the special symbol display device 33) or equal to or greater than “15” (in the case where a specific numerical symbol of “7” was statically displayed on the special symbol display device 33) (indicative of a final round) is satisfied. If any of the conditions is satisfied, the main CPU 66 sets the control state flag to a value (07) indicative of a big-hit completion interval and also sets the waiting time timer to a time corresponding to the big-hit completion interval. Namely, the main CPU 66 sets the configuration such that the process in step S80 is conducted after the elapse of a time corresponding to the big-hit completion interval. Further, the main CPU 66 increments the number-of-special-games counter in the main RAM 70 by “1”.

On the other hand, if both the conditions are not satisfied, the main CPU 66 sets the control stage flag to a value (06) indicative of special winning opening re-opening waiting time management. Further, the main CPU 66 updates the number-of-rounds display counter stored in the main RAM 70 such that the stored value is subtracted by “1”. Further, the main CPU 66 sets the waiting time timer to a time corresponding to the inter-round interval. Namely, the main CPU 66 sets the configuration such that the process in step S76 is conducted after the elapse of the time corresponding to the inter-round interval. After the completion of this process, the subroutine proceeds to the proceeds in step S80.

In step S80, big-hit completion interval process is conducted. In this process, the control state flag has the value (07) indicative of the big-hit completion interval and, after the elapse of the time corresponding to the big-hit completion interval, the main CPU 66 sets the control state flag to a value (08) indicative of the completion of special symbol games. Namely, the main CPU 66 sets the configuration such that the process in step S81 is conducted. After the completion of this process, the subroutine proceeds to the process in step S81.

In step S81, a special symbol game completion process is conducted. In this process, when the control state flag has a value (08) indicative of the completion of special symbol games, the main CPU 66 updates the data indicative of the number of holds relating to special symbols (starting storage information) such that it is subtracted by “1”. Further, the main CPU 66 sets data indicative of a number-of-starting-storage designation command for subtracting the starting storage information by “1” in a predetermined storage region of the main RAM 70. Further, the main CPU 66 updates the special symbol storage region, in order to perform the next variable display. The main CPU 66 sets the control state flag to a value (00) indicative of special symbol storage checking. Namely, the main CPU 66 sets the configuration such that the process in step S72 is conducted. After the completion of this process, this subroutine ends.

As previously described, by setting the control state flag, special symbol games are executed. Specifically, as illustrated in FIG. 17, when the game state is not a big-hit game state, if “failure” is resulted from a big-hit determination, the main CPU 66 sets the control flag state to “00”, “01”, “02” and “08” in the mentioned order to conduct the process in steps S72, S73, S74 and S81 illustrated in FIG. 16 at predetermined timing. Also, when the game state is not a big-hit game state, if a big hit is resulted from a big-hit determination, the main CPU 66 sets the control flag state to “00”, “01”, “02” and “03” in the mentioned order to conduct the process in steps S72, S73, S74 and S75 illustrated in FIG. 16 at predetermined timing to perform the control of a big-hit game state. Also, when the control of the big-hit game state is performed, the main CPU 66 sets the control flag state to “04”, “05” and “06” in the mentioned order to conduct the process in steps S78, S79 and S77 illustrated in FIG. 16 at predetermined timing to perform special games. Further, if the condition for completing special games (a big-hit game state) (the condition for completing special games, the condition for completing big-hit games) is satisfied, the main CPU 66 sets the control state flag to “04”, “05”, “07” and “08” in the mentioned order to conduct the process in steps S78 to 81 illustrated in FIG. 16 at predetermined timing to complete special games. Further, in the present embodiment, the condition for completing special games includes the condition that no gaming ball has passed through the specific region until a predetermined time has elapsed (“blown out state”) and the condition that the maximum number of continuous rounds (“2” rounds or “15” rounds, in the present embodiment) has been completed.

(Special Symbol Storage Check Process)

With reference to FIG. 18, the subroutine conducted in step S72 in FIG. 16 will be described.

First, as illustrated in FIG. 12, the main CPU 66 determines whether or not the control state flag has the value (00) indicative of special symbol storage check (step S101). If it is determined that the control state flag has the value indicative of special symbol storage check, the subroutine proceeds to the process in step S102 and, if it is not determined that the control state flag has the value indicative of special symbol storage check, this subroutine ends.

In step S102, the main CPU 66 determines whether or not the number of holds relating to special symbols is “0”. If it is determined that the data indicative of the number of holds relating to special symbols is “0”, then the subroutine proceeds to the process in step S103 and, if it is not determined that the data indicative of the number of holds is “0”, then the subroutine proceeds to the process in step S104.

In step S103, a demonstration display process is conducted. In this process, the main CPU 66 stores, in the main RAM 70, a variable value used for transmitting a demonstration display command to the sub control circuit 200 for causing it to perform demonstration displaying. This causes the sub control circuit 200 to display a demonstration screen. After the completion of this process, this subroutine ends.

In step S104, a process for setting the control state flag to the value (01) indicative of special symbol variation time management is conducted. In this process, the main CPU 66 stores the value indicative of special symbol variation time management in the control state flag. After the completion of this process, the subroutine proceeds to the process in step S105.

In step S105, a big-hit determination process is conducted. In this process, the main CPU 66 selects a big-hit determination value stored in the big-hit determination table. Further, the main CPU 66 refers to the big-hit determination random number extracted at starting winning and the big-hit determination value. Namely, the main CPU 66 determines whether or not a big-hit game state advantageous to the player should be occurred. After the completion of this process, the subroutine proceeds to the process in step S106. As described above, the main CPU 66 is exemplary lottery means for performing lottery for determining whether or not special games should be executed.

In step S106, it is determined whether or not a big hit has occurred. In this process, the main CPU 66 determines whether or not a big hit has occurred, on the basis of the result of the reference in step S105. If the main CPU 66 determines that a big hit has occurred, the subroutine proceeds to the process in step S107 and, if it does not determine that a big hit has occurred, the subroutine proceeds to the process in step S108.

In step S107, a big-hit symbol determination process is conducted.

In this process, the main CPU 66 extracts a big-hit symbol random number extracted at starting winning, then determines a special symbol to be statically displayed on the special symbol display device 33 on the basis of the big-hit symbol determination random number and stores data indicative of the special symbol in a predetermined region of the main RAM 70. After the completion of this process, the subroutine proceeds to the process in step S109.

In step S108, a failure symbol determination process is conducted.

In this process, the main CPU 66 extracts a failure symbol determination random number from a failure symbol determination random number counter, then determines a special symbol to be statically displayed on the special symbol display device 33 as a failure symbol and stores data indicative of the special symbol in a predetermined region of the main RAM 70. After the completion of this process, the subroutine proceeds to the process in step S109.

Next, in step S109, a variation pattern determination process is conducted. In this process, the main CPU 66 extracts an effect condition selection random number. The main CPU 66 selects a variation pattern dispersion table for determining the variation pattern of effect identification information images including output information, on the basis of the special symbol determined in step S107 and step S108. Specifically, a variation pattern dispersion table is selected such that the effect displaying time for the special symbol determined in step S107 and step S108 is increased in the order of the failure special symbol and the big-hit special symbol. Then, the main CPU 66 determines an effect variation pattern, on the basis of the effect condition selection random number extracted from the effect condition selection random number counter and the selected variation pattern dispersion table, and stores it in a predetermined region of the main RAM 70. After the completion of this process, the subroutine proceeds to the process in step S110.

Then, in step S109, data indicative of the stored variation pattern is supplied, as a variation pattern designation command, from the main CPU 66 in the main control circuit 60 to the sub CPU 206 in the sub control circuit 200, through the process in step S47 in FIG. 15. In accordance with the received variation pattern designation command, on the basis of an effect pattern set in the predetermined region of the work RAM 210, the sub CPU 206 in the sub control circuit 200 transmits data for displaying the effect pattern, to the display control circuit 250. On the basis of the data for displaying the effect pattern, the display control circuit 250 controls the display of effects on the liquid crystal display device 32. As described above, the display control circuit 250 is exemplary display control means for controlling the display of effect images on the display means.

In step S110, a process for setting the waiting time timer to a varying time corresponding to the determined effect variation pattern is conducted. In this process, the main CPU 66 reads, from a table, a variation time corresponding to the effect variation pattern determined through the process in step S109 and stores the value indicative of the variation time in the waiting time timer. Then, a process for clearing the storage region which stores the big-hit determination random number and the like used for the current variable display is conducted (step S111). After the completion of this process, this subroutine ends.

(Operations of Sub Control Circuit)

On the other hand, the sub control circuit 200 receives various types of commands transmitted from the main control circuit 60 and executes the following effects.

(Output Information Image Display Control Process)

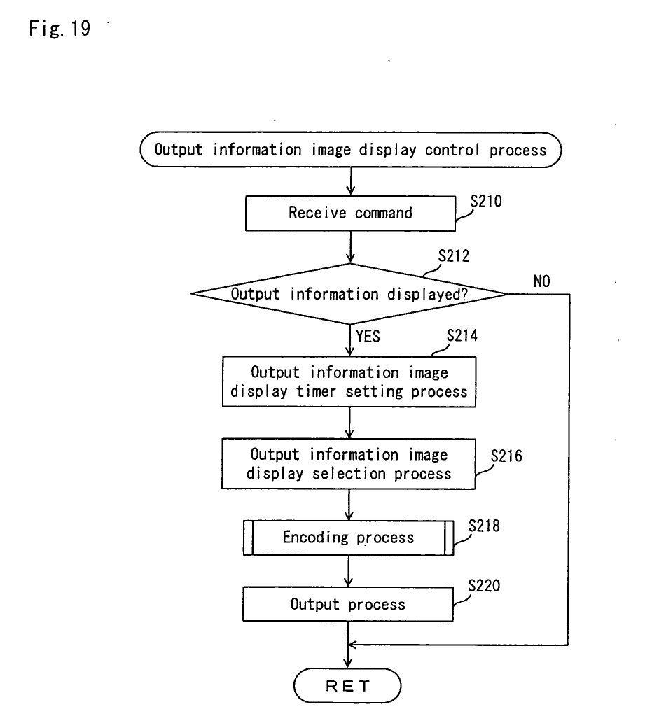

Hereinafter, with reference to FIG. 19, there will be described an output information image display control process in the liquid crystal display device 32.

In step S210, a command reception process is conducted. In this process, the sub CPU 206 receives a variation pattern designation command transmitted from the main CPU 66. After the completion of this process, the subroutine proceeds to the process in step S212.

In step S212, it is determined whether or not an output information image should be displayed. In this process, on the basis of the variation pattern designation command received in step S210, the sub CPU 206 determines whether or not an output information image should be displayed. Specifically, when the combination of effect identification information 94a and 94c to be statically displayed is at a reach state, on the basis of the variation pattern designation command, and a reach effect image as illustrated in FIG. 8 is to be displayed on the display region 32a of the liquid crystal display device 32, the sub CPU 206 selects an output information image display notification effect pattern stored in the program ROM 208. Further, the sub CPU 206 sets an output information image display notification effect pattern in the predetermined region of the work RAM 210. After the completion of this process, the subroutine proceeds to the process in step S214. On the other hand, if an output information image is not to be displayed, this subroutine ends.

In step S214, an output information image display timer setting process is conducted. In this process, the sub CPU 206 selects an output information image display timer stored in the program ROM 208. Further, the sub CPU 206 sets the output information image display timer in a predetermined region of the work RAM 210. After the completion of this process, the subroutine proceeds to the process in step S216.

In step S216, an output information image display selection process is conducted. In this process, the sub CPU 206 selects output information (information 340), from the output information table stored in the program ROM 208 (see FIG. 12), on the basis of the reach effect image to be displayed on the basis of the variation pattern designation command. Specifically, in the case where Niagara Reach is selected on the basis of the variation pattern designation command and a reach effect image relating to Niagara Reach is to be displayed on the display region 32a of the liquid crystal display device 32, output information A is selected. Further, the sub CPU 206 selects an output information image display-related effect pattern. Further, the sub CPU 206 sets the selected output information and the selected output information image display-related effect pattern, in a predetermine region of the work RAM 210. After the completion of this process, the subroutine proceeds to the process in step S218.

In step S218, an encoding process is conducted. In this process, as will be described in detail later, the sub CPU 206 determines the generation time 350, encodes data for generating the output information image, the shop ID 310, the machine model ID 320 and the product ID 330 stored in the program ROM 208 and sets the data for displaying the output information image, in a predetermined region of the work RAM 210. After the completion of this process, the subroutine proceeds to the process in step S220.

In step S220, an output process is conducted. In this process, the sub CPU 206 transmits data for displaying an output information image display notification effect image to the display control circuit 250, on the basis of the output information image display notification effect pattern set in the predetermined region of the work RAM 210. Further, after the elapse of a predetermined time based on the output information image display timer set in the predetermined region of the work RAM 210, the sub CPU 206 transmits the data for displaying the output information image and data for displaying output information image display-related effect images based on the output information image display-related effect pattern, which are set in the predetermined regions of the work RAM 210, to the display control circuit 250. After the completion of this process, the subroutine ends.

As described above, in the display control circuit 250, the VDP 212 displays a two-dimensional code 300a (see FIG. 1) on the display region 32a of the liquid crystal display device 32, on the basis of the data for displaying a two-dimensional code generated in step S218. Namely, the display control circuit 250 is exemplary display control means for conducting a control for displaying an output information image in such a manner that it can be captured from the outside.

In addition to the aforementioned process, the VDP 212 reads various types of image data such as effect identification information data indicative of effect identification information images, background image data, and effect image data, from the image data ROM 216, on the basis of data for displaying effect patterns from the sub CPU 206, superimposes them on one another and displays them on the display region 32a of the liquid crystal display device 32.

With this process, effect identification information is variably displayed on the display region 32a of the liquid crystal display device 32 and, after the elapse of a predetermined time, effect identification information is statically displayed on the display region 32a of the liquid crystal display device 32.

(Encoding Process)

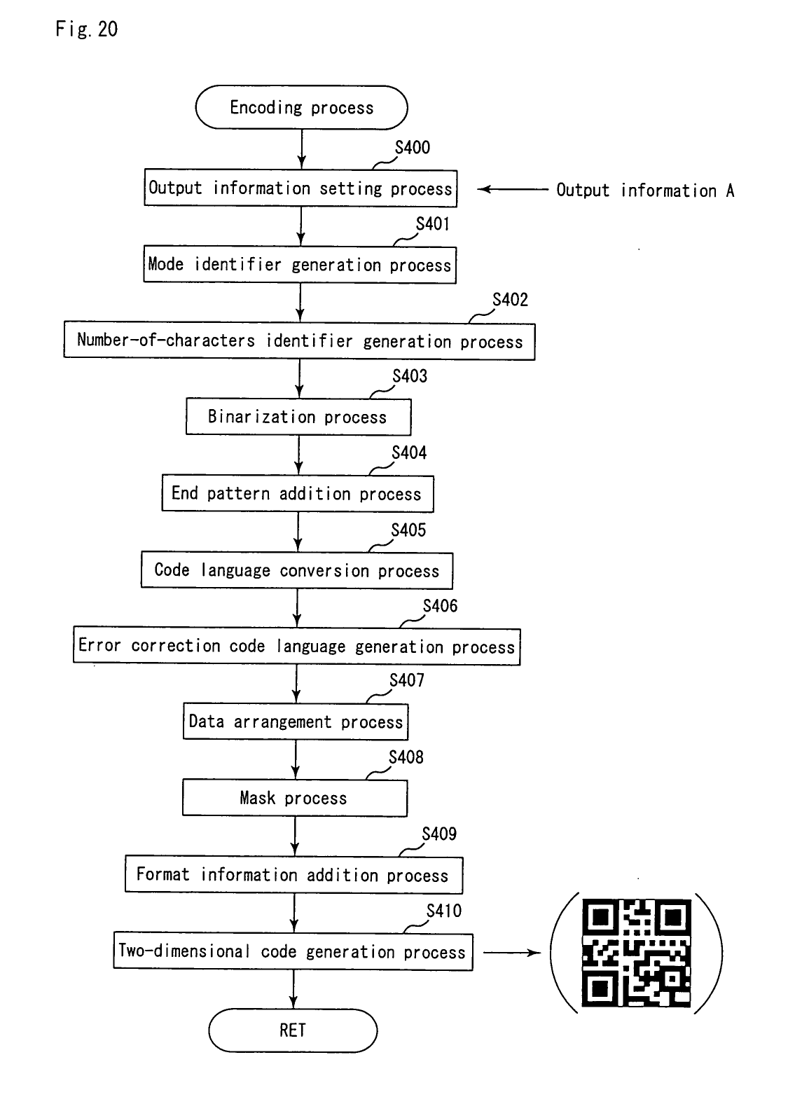

With reference to FIG. 20, there will be described the subroutine which is called up in step S218 in FIG. 19.

In step S400, an output information storage process is conducted. In this process, the sub CPU 206 sets, in a predetermined region of the work RAM 210, the generation time of the output information 350, the output information (for example, the information 340) set in the work RAM 210 and the data of the shop ID 310, the machine model ID 320, the product ID 330, the generation time 350 and the like, which has been stored in the program ROM 208. In the figure, as an example of output information, there is illustrated the output information A. After the completion of this process, the subroutine proceeds to the process in step S401.

In step S401, a mode identifier generation process is conducted. In this process, the sub CPU 206 generates a mode identifier according to the figures (for example, numerical characters, alphanumeric characters, Chinese Characters), in the work RAM 210. After the completion of this process, the subroutine proceeds to the process in step S402.

In step S402, a number-of-characters identifier generation process is conducted. In this process, the sub CPU 206 generates a number-of-characters identifier according to the number of characters and the like, in the work RAM 210. After the completion of this process, the subroutine proceeds to the process in step S403.

In step S403, a binarization process is conducted. In this process, the sub CPU 206 performs a process for binarizing the data. After the completion of this process, the subroutine proceeds to the process in step S404.

In step S404, an end pattern addition process is conducted. In this process, the sub CPU 206 performs a process for adding an end pattern to the data obtained in steps S401 to S403. After the completion of this process, the subroutine proceeds to the process in step S405.

In step S405, a code language conversion process is conducted. In this process, the sub CPU 206 performs code language conversion on the data obtained in step S404. After the completion of this process, the subroutine proceeds to the process in step S406.

In step S406, an error correction code language generation process is conducted. In this process, the sub CPU 206 generates an error correction code language, on the basis of the data obtained in step S405, and adds it to the data obtained in step S405. After the completion of this process, the subroutine proceeds to the process in step S407.

In step S407, a data arrangement process is conducted. In this process, the sub CPU 206 conducts a process for binarizing the data obtained in step S406 and then arranging it in a matrix form. After the completion of this process, the subroutine proceeds to the process in step S408.

In step S408, a masking process is conducted. In this process, the sub CPU 206 conducts a process for masking the data obtained in step S407 with a predetermined pattern. After the completion of this process, the subroutine proceeds to the process in step S409.

In step S409, a format information addition process is conducted. In this process, the sub CPU 206 conducts a process for adding format information including an error correction level and a mask identifier. After the completion of this process, the subroutine proceeds to the process in step S410.

In step S410, a two-dimensional code generation process is conducted. In this process, the sub CPU 206 generates data for displaying the two-dimensional code and stores the data for displaying the two-dimensional code in the work RAM 210. After the completion of this process, the subroutine ends.

While, in the present embodiment, there has been described a case where the output information A to E is encoded (coded) into two-dimensional codes, image data for waiting images, music data for cellular phone ring melodies and the like, as well as the aforementioned data, may be encoded in the present invention. Further, service points or game information may be encoded. Also, various types of programs such as games may be encoded. Further, various types of programs such as games may be encoded.

Further, the liquid crystal display device 32 corresponds to exemplary display means for displaying images. Further, the display control circuit 250 corresponds to exemplary display control means.

(Structure of Portable Telephone)

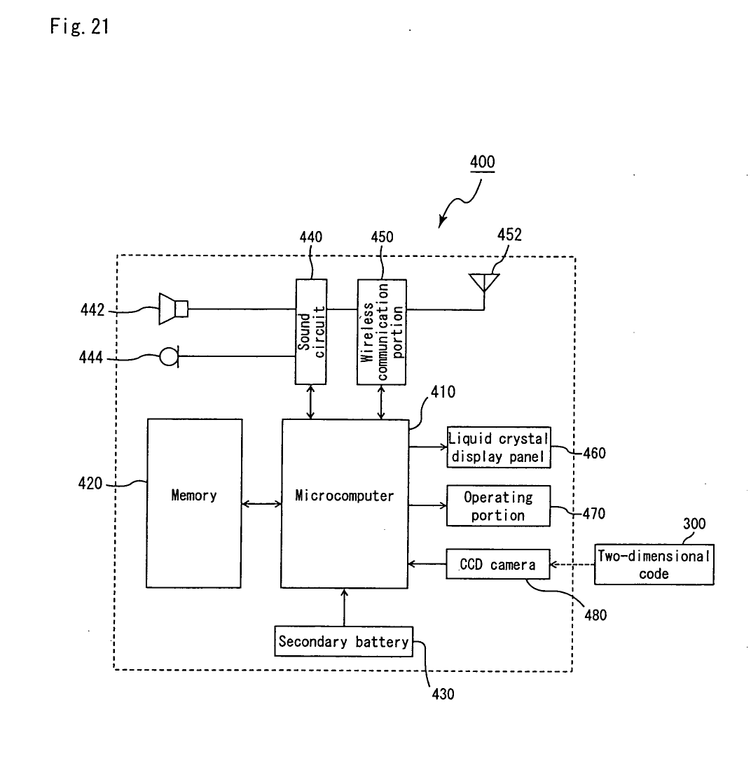

FIG. 21 is a block diagram illustrating the internal structure of the portable terminal device 400 illustrated in FIG. 1. The portable terminal device 400 includes an operating portion 470, a liquid crystal panel 460, a CCD camera 480 as image pickup means, a wireless communication portion 450, a sound circuit 440, a speaker 442, a microphone 444, a transmission/reception antenna 452, a memory 420, a microcomputer 410 and a secondary battery 430.

The wireless communication portion 450 performs transmission and reception to and from a base station, by using radio waves as a medium, through the transmission/reception antenna 452, under the control of the microcomputer 410. The sound circuit 440 outputs, to the speaker 442, reception signals output from the wireless communication portion 450 through the microcomputer 410 and also outputs sound signals output from the microphone 444, as transmission signals, to the wireless portion 450 through the microcomputer 410.

The speaker 442 converts the reception signals output from the sound circuit 440 into reception sounds and outputs them, and the microphone 444 converts transmission sounds generated by an operator into sound signals and outputs them to the sound circuit 440.

The CCD camera 480 is capable of capturing a two-dimensional code 300a (see FIG. 1) displayed on the liquid crystal display device 32 of the pachinko gaming machine 10, and the image data obtained from the capturing is stored in the memory 420. While, in the present embodiment, there will be described a case where the CCD camera is employed as the image pickup means, the image pickup means is not particularly limited and may be, for example, a CMOS sensor camera in the present invention.

The memory 420 stores, in a nonvolatile manner, various types of data such as image data generated by capturing the two-dimensional code 300a with the CCD camera 480, image data for waiting images, sound data for cellular phone ring melodies, URL data, and various types of programs.

The secondary battery 430 supplies electric power to the respective circuits. The microcomputer 410 is constituted by a CPU, a ROM and a RAM and performs, for example, phone incoming/outgoing call processing, e-mail generating, transmitting and receiving processing, internet processing and the like. The transmission/reception of e-mails and the transmission/reception of data through the Internet are performed by the microcomputer 410, through the wireless communication portion 450 and the transmission/reception antenna 452.

The microcomputer 410 drives the CCD camera 480 to capture the two-dimensional code 300a with the CCD camera 480 (see FIG. 1), on the basis of a predetermined command input through the operating portion 470, and then stores the resultant image data in the memory 420.

The microcomputer 410 conducts a process for reading the image data stored in the memory 420 and then displaying the two-dimensional code 300b (see FIG. 1) on the liquid crystal panel 460, on the basis of a predetermined command input through the operating portion 470.

(Structure of Server)

FIG. 22 is a block diagram illustrating the internal structure of the server 600 illustrated in FIG. 1. The server 600 includes a microcomputer 610 as extraction means and benefit information transmission means, a hard disk drive 620 as information storage means, an external input terminal 630, an external output terminal 640 and a communication interface 650 as reception means and benefit information transmission means.

The microcomputer 610 is constituted by a CPU, a RAM, a ROM and conducts a process for extracting information from the hard disk drive 620 and other processes. The hard disk drive 620 functions as information storage means for storing information (for example, data) to be transmitted to the portable terminal device 400, in association with output information. Further, the hard disk drive 620 stores a data table (see FIG. 28) which is referred to in extracting data (for example, waiting-image image data, encouraging image data, music data for cellular phone ring melodies), on the basis of image information received from the portable terminal device 400.

On receiving the image information A to E and the ID data of the portable terminal device 400 from the portable terminal device 400, the microcomputer 610 reads stored image information and a data table (see FIG. 28) which will be described later, from the hard disk drive 620. On the basis of the image information stored in the hard disk drive 620 and the data table, the microcomputer 610 selects an URL and reads data indicative of the site associated with the selected URL (for example, HTML data or the like). Then, it transmits the data to the portable terminal device 400 through the communication interface 650, through the Internet 500. As a result, the site associated with the selected URL is displayed on the liquid crystal panel 460 of the portable terminal device 400. In this case, if image information based on a predetermined number of types of reach effect images has been stored in the hard disk drive 620, waiting-image image data can be acquired from this site. This waiting-image image data is read from the hard disk drive 620 along with the URL and is transmitted to the portable terminal device 400. As a result, the site associated with the URL as output information is displayed on the liquid crystal panel 460 of the portable terminal device 400 and waiting-image image data can be acquired from this site. On the other hand, if the image information stored in the hard disk drive 620 is not image information based on predetermined number of types of reach effect images, waiting-image image data can not be acquired from this site. In this case, although the site associated with the received URL is displayed on the liquid crystal panel 460 of the portable terminal device 400, waiting-image image data can not be acquired from this site and encouraging image data which will be described later is transmitted to the portable terminal device 400 to notify the player that reach effect images should be further displayed.

Also, while, in the present embodiment, if the image information stored in the hard disk drive 620 is not image information based on the predetermined number of types of reach effect images, encouraging image data which will be described later is transmitted to the portable terminal device 400, it is not essential that the encouraging image data is transmitted.

Further, the hard disk drive 620 stores programs to be downloaded to the portable terminal device 400. On receiving a signal commanding for downloading a program therefrom from the portable terminal device 400, the microcomputer 610 reads the program from the hard disk drive 620 and transmits the program to the portable terminal device 400 through the communication interface 650 and through the Internet.

Herein, the structure of the server 600 is not limited to the aforementioned structure and it is possible to employ other well-known server structures including information storage means, extraction means and benefit information transmission means.

(Processes Between Gaming Machine and Portable Telephone)

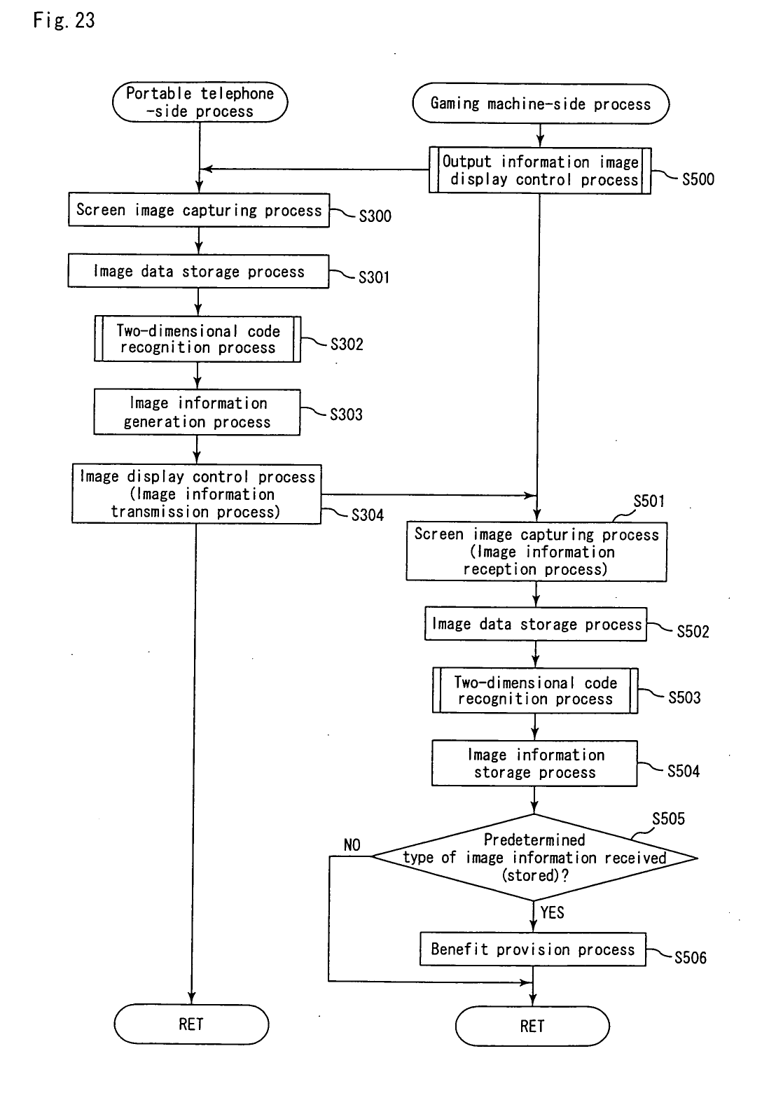

FIG. 23 is a flowchart illustrating a process conducted between the portable terminal device 400 and the pachinko gaming machine 10.

In step S500, as illustrated in FIG. 19, an output information image display control process is conducted. In this process, if the sub CPU 206 receives a variation pattern command and a predetermined condition is satisfied, for example, a predetermined reach effect image is displayed, then the display control circuit 250 of the pachinko gaming machine 10 displays an image of a two-dimensional code 300a on the liquid crystal display device 32. After the completion of this process, the subroutine proceeds to the process in step S300.

In step S300, a screen image capturing process is conducted. In this process, the microcomputer 410 included in the portable terminal device 400 drives the CCD camera 480 as image pickup means, on the basis of a command input through the operating portion 470. The CCD camera 480 captures the two-dimensional code 300a included in the screen image displayed on the liquid crystal display device 32 of the pachinko gaming machine 10. After the completion of this process, the subroutine proceeds to the process in step S301.

In step S301, an image data storage process is conducted. In this process, the microcomputer 410 stores the image data obtained in step S300 in the memory 420. After the completion of this process, the subroutine proceeds to the process in step S302.

In step S302, a two-dimensional code recognition process is conducted. In this process, the microcomputer 410 conducts two-dimensional code recognition process to recognize the output information image such as the two-dimensional code 300a from the image data obtained in step S300 and generates data (output information) from the recognized two-dimensional code. The two-dimensional code recognition process will be described in detail later. After the completion of this process, the subroutine proceeds to the process in step S303.

In step S302, the microcomputer 410 functions as information generation means for recognizing the two-dimensional code 300a from the image data generated by capturing the two-dimensional code 300a through the CCD camera 480 and generating data (output information) from the recognized two-dimensional code.

In step S303, an image information generation process is conducted. In this process, the microcomputer 410 generates image information (for example, an image such as a two-dimensional code 300b), on the basis of an image information table (see FIG. 25) which will be described later, from the data (output information) obtained in step S302. After the completion of this process, the subroutine proceeds to the process in step S304.

In step S304, an image display control process is conducted. In this process, the microcomputer 410 controls for displaying the image information obtained in step S303 on the liquid crystal panel 460. After the completion of this process, the subroutine proceeds to the process in step S501. While, in the present embodiment, a two-dimensional code as output information is displayed on the liquid crystal panel 460, other image information such as a one-dimensional code (a bar code) or other images may be displayed thereon. After the completion of this process, the subroutine proceeds to the process in step S501.

In step S304, the two-dimensional code 300b including the image information is read by the reading device 50 of the pachinko gaming machine 10 for transmitting the image information to the pachinko gaming machine 10. Namely, the microcomputer 410 conducts an image information transmission process for transmitting the image information, in step S303.

In step S501, a screen image capturing process is conducted. In this process, the microcomputer 410 included in the portable terminal device 400 drives the CCD camera 480 as image pickup means, on the basis of a command input through the operating portion 470, and the CCD camera 480 captures the two-dimensional code 300b displayed on the liquid crystal display device 32 of the pachinko gaming machine 10. After the completion of this process, the subroutine proceeds to the process in step S502.

In step S501, the two-dimensional code 300b including the image information is read by the reading device 50 of the pachinko gaming machine 10 for receiving the image information in the pachinko gaming machine 10. Namely, when the operating switch 264 is operated, the reading device 50 conducts an image information reception process for receiving the image information displayed on the liquid crystal panel 460 of the portable terminal device 400. At this time, the reading device 50 functions as reception means for receiving information based on the output information image, as image information, from the outside.

In step S502, an image data storage process is conducted. In this process, the reading device 50 stores the image data obtained in step S501 in the memory 269. After the completion of this process, the subroutine proceeds to the process in step S503.

In step S503, a two-dimensional code recognition process is conducted. In this process, the reading device 50 conducts a two-dimensional code recognition process to recognize the two-dimensional code from the image data obtained in step S501 and generates image information from the recognized two-dimensional code. The two-dimensional code recognition process will be described in detail later. After the completion of this process, the subroutine proceeds to the process in step S504.

In step S504, an image information storage process is conducted. In this process, the reading device 50 receives the image information included in the two-dimensional code 300b from the portable terminal device 400 through the Internet and stores the image information generated through the aforementioned two-dimensional code recognition process in the memory 269. After the completion of this process, the subroutine proceeds to the process in step S505. As described above, the memory 269 is exemplary information storage means for storing image information.

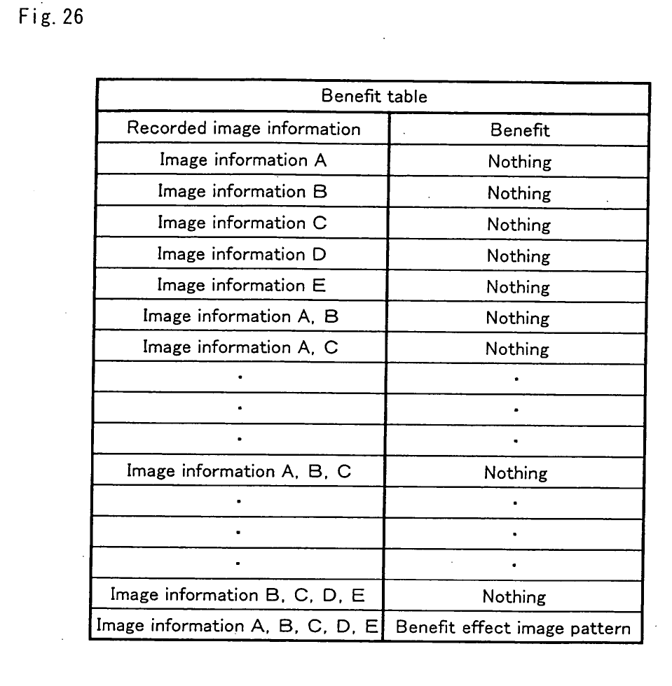

In step S505, it is determined whether or not predetermined types of image information have been received (stored). In this process, the reading device 50 refers to a benefit table (FIG. 26) stored in the memory 296 to determine whether or not predetermined types of image information have been stored in the memory 296. Then, if it determines that predetermined types of image information have been received, a benefit provision process is conducted (step S506). Specifically, when all the image information A to E has been stored, a benefit effect image pattern is provided to the player as a benefit. Then, the reading device 50 sends a benefit display command to the sub CPU 206, in order to cause a benefit effect image (pattern) to be displayed on the display region 32a of the liquid crystal display device 32. On the basis of the received benefit displaying command, the sub CPU 206 sends an effect display command to the display control circuit 250, in order to cause a special effect image to be displayed on the display region 32a of the liquid crystal display device 32. On the other hand, if the predetermined types of image information have not been stored in the memory 296, the reading device 50 conducts a control for providing no benefit to the player. Specifically, as illustrated in the benefit table, if the image information A is stored in the memory 296, no benefit is provided to the player. Similarly, if the image information A and B is stored in the memory 296 or if the image information A, B and C is stored in the memory 296, no benefit is provided to the player.

After transmitting the benefit display command to the sub CPU 206, the reading device 50 clears the image information stored in the memory 296. After the completion of this process, this process ends.

As described above, two-dimensional codes 300a including output information associated with plural types of reach effect images are captured by the portable terminal device 400 from the outside and, as a result, image data based on the any types of two-dimensional codes 300a is generated, and information relating to the resultant image data is received from the portable terminal device 400 as image information associated with the reach effect images. Then, on the condition that the pachinko gaming machine 10 has received all the image information associated with predetermined types of reach effect images, for example, 5 types of reach effect images in the present embodiment, a benefit effect image pattern is displayed, as a predetermined benefit, on the display region 32a of the liquid crystal display device 32. Namely, in order to provide a predetermined benefit, the following actions should be performed for predetermined types of reach effect images, which requires the player to make efforts during games. For example, output information images associated with plural types of reach effect images are captured by the portable terminal device 400 to generate image data, and image information associated with the reach effect images, which is based on the generated image data, is transmitted to the pachinko gaming machine 10. As described above, as a condition for providing a predetermined benefit to the player, the player is required to make efforts during games, which provides a new game aspect to the player, thereby enhancing his or her interest in games.

Further, the reading device 50 for conducting the process in step S506 is exemplary benefit control means for conducting a control for providing a predetermined benefit, on the condition that image information associated with the aforementioned reach effect images of predetermine types has been received.

(Two-Dimensional Code Recognition Process)

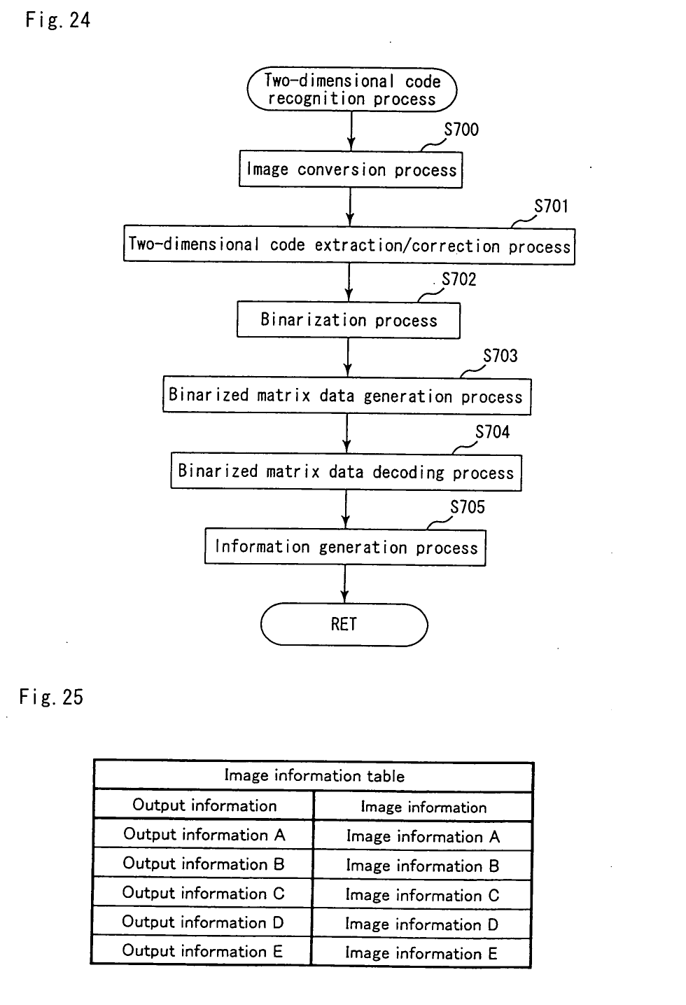

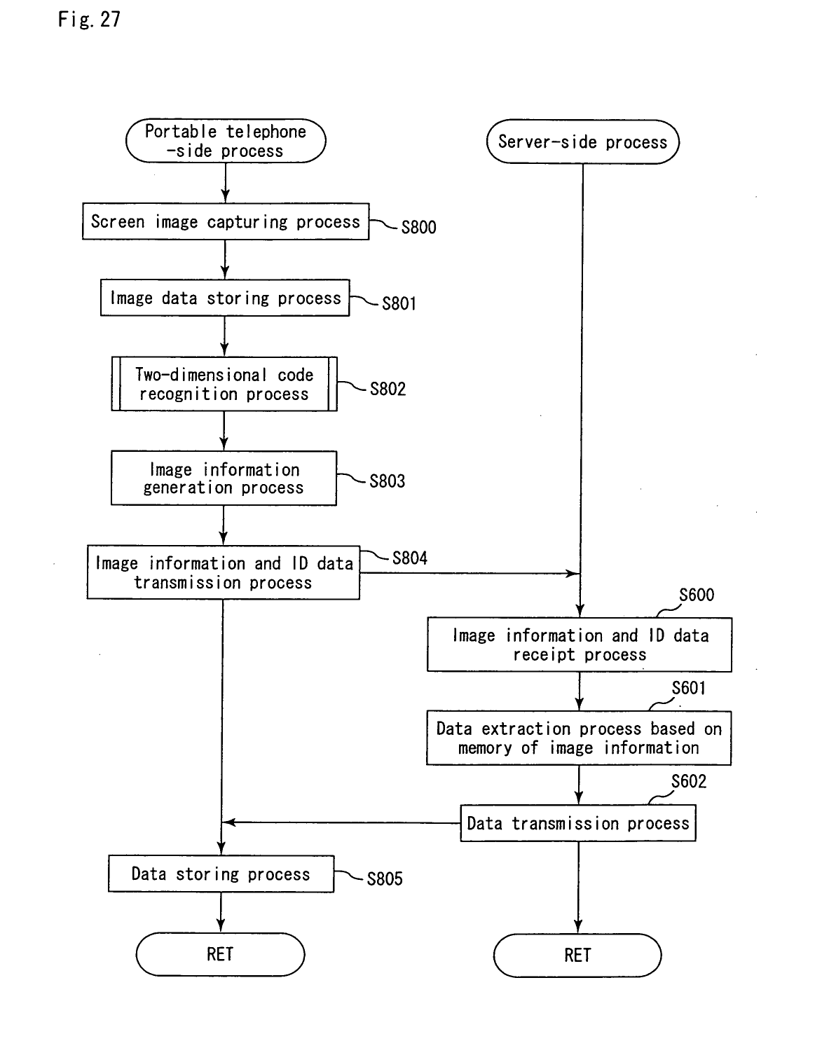

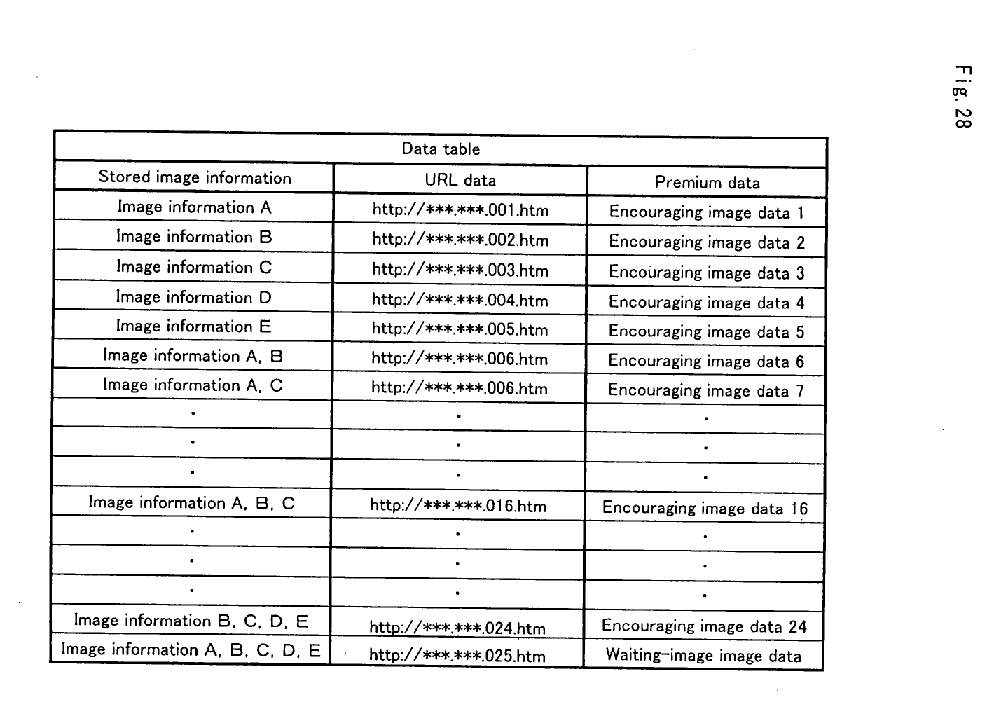

FIG. 24 is a flowchart illustrating the two-dimensional code recognition process which is conducted in the portable terminal device 400 in step S302 in FIG. 23 and step S802 in FIG. 27.

In step S700, an image conversion process is conducted. In this process, the microcomputer 410 conducts an image conversion process on the image data stored in the memory 420. The image conversion process is a process for extracting image data of the region at which an output information image such as a two-dimensional code is displayed, from the image data obtained by capturing, then correcting the inclination or distortion thereof and converting it into a monochrome image with a predetermined threshold value to provide image data including the two-dimensional code viewed from the front side thereof. After the completion of this process, the subroutine proceeds to the process in step S701.

In step S701, a two-dimensional code extraction/correction process is conducted. In this process, the microcomputer 410 extracts the two-dimensional code from the image data obtained in step S700 and performs corrections such as noise elimination. After the completion of this process, the subroutine proceeds to the process in step S702.

In step S702, a binarization process is conducted. In this process, the microcomputer 410 conducts a binarization process on the two-dimensional code obtained in step S701 and substitutes “0” or “1” for the respective dots constituting the two-dimensional code. After the completion of this process, the subroutine proceeds to the process in step S703.

In step S703, a binarized matrix data generation process is conducted. In this process, the microcomputer 410 generates binarized matrix data, from the two-dimensional code constituted by “0” and “1” substituted for the dots, which has been resulted from the binarization process in step S702. After the completion of this process, the subroutine proceeds to the process in step S704.

In step S704, a binarized matrix data decoding process is conducted. In this process, the microcomputer 410 decodes the binarized matrix data. After the completion of this process, the subroutine proceeds to the process in step S705.

In step S705, an information generation process is conducted. In this process, the microcomputer 410 generates output information and image information. After the completion of this process, this subroutine ends.

FIG. 25 is a view illustrating an exemplary image information table used in step S303 in FIG. 23. As illustrated in FIG. 25, the image information table stored in the memory 420 (see FIG. 21) of the portable terminal device 400 stores output information and image information, in association with each other.

For example, on the basis of output information A resulted from the process in step S302, image information A is generated. Similarly, image information B is generated on the basis of output information B, image information C is generated on the basis of output information C, image information D is generated on the basis of output information D, and image information E is generated on the basis of output information E.

FIG. 26 is a view illustrating an exemplary benefit table used in step S506 in FIG. 23. As illustrated in FIG. 26, the benefit table stored in the memory 296 (see FIG. 13) in the reading device 50 stores image information stored in the memory 296 and benefits in association with each other.

For example, when image information A is stored in the memory 296, when image information A and B is stored in the memory 296 and when image information A, B and C is stored in the memory 296, no benefit is provided to the player. On the other hand, when information A, B, C, D and E is stored in the memory 296, a benefit effect image pattern, which is a special effect image, is displayed on the display region 32a of the liquid crystal display device 32, as a benefit provided to the player.

(Process Between Server and Portable Telephone)

FIG. 27 is a flowchart illustrating a process conducted between the portable terminal device 400 and the server 600.

In step S800, a screen image capturing process is conducted. In this process, the microcomputer 410 included in the portable terminal device 400 drives the CCD camera 480 as image pickup means, on the basis of a command input through the operating portion 470, and the CCD camera 480 captures a two-dimensional code 300a displayed on the liquid crystal display device 32 of the pachinko gaming machine 10. After the completion of this process, the subroutine proceeds to the process in step S801.

In step S801, an image data storage process is conducted. In this process, the microcomputer 410 stores the image data obtained in step S800 in the memory 420. After the completion of this process, the subroutine proceeds to the process in step S802.

In step S802, a two-dimensional code recognition process is conducted. In this process, the microcomputer 410 conducts a two-dimensional code recognition process to recognize the output information image such as the two-dimensional code 300a from the image data obtained in step S800 and generates data (output information) from the recognized two-dimensional code. The two-dimensional code recognition process will be described in detail later. After the completion of this process, the subroutine proceeds to the process in step S803.

In step S802, the microcomputer 410 functions as output information generation means for recognizing output information images such as the two-dimensional code 300a from the image data generated by capturing the two-dimensional code 300a through the CCD camera 480 and generating data (output information) from the recognized two-dimensional code.

In step S803, an image information generation process is conducted. In this process, the microcomputer 410 generates image information from the data obtained in step S802. After the completion of this process, the subroutine proceeds to the process in step S804.

In step S804, an image information/ID data transmission process is conducted. In this process, the microcomputer 410 transmits the data resulted from the two-dimensional code recognition process in step S802 along with the ID data of the portable terminal device 400, to the server 600, through the wireless communication portion 450 and the transmission/reception antenna 452, through the Internet 500 (see FIG. 1). After the completion of this process, the subroutine proceeds to the process in step S600.

In step S804, the microcomputer 410 functions as a data (benefit information) transmission means for transmitting the data generated in step S502 to the server 600.

In step S600, an image information/ID data reception process is conducted. In this process, the microcomputer 610 included in the server 600 receives the image information and the ID data of the portable terminal device 400, from the portable terminal device 400, through the Internet and the communication interface 650. Further, the microcomputer 610 stores the aforementioned image information and the ID data in the hard disk drive 620. After the completion of this process, the subroutine proceeds to the process in step S601. The hard disk drive 620 and communication interface 650 are exemplary reception means. The hard disk drive 620 is also exemplary storage means for storing information (data) such as image information, and ID information.

In step S601, a data extraction process based on the image information is conducted. In this process, the microcomputer 610 refers to the data table as illustrated in FIG. 28 and extracts, from the hard disk drive 620, URL data and supply information (information relating to a predetermined benefit) associated with the site displayed with the URL data, Specifically, premium data (for example, waiting-image image data, encouraging image data, data of service points and a cellular phone ring melody and the like) associated therewith, if any, on the basis of the image information stored in the hard disk drive 620.

For example, when image information A is stored in the hard disk drive 620, an URL (http://***.***.001.htm) is extracted as URL data and also encouraging image data 1 is extracted as premium data to be extracted. This encouraging image data is data of an encouraging image indicating that reach effect images are further required to be displayed. On the other hand, when image information A, B, C, D and E is stored in the hard disk drive 620, an URL (http://***.***.025.htm) is extracted as URL data and also waiting-image mage data is extracted as premium data. Thus, when the process in step S601 is conducted, the microcomputer 610 functions as extraction means for extracting premium data from the hard disk drive 620 (information storage means), on the basis of image information received from the portable terminal device 400. After the completion of this process, the subroutine proceeds to the process in step S602.

In step S602, a data transmission process is conducted. In this process, the microcomputer 610 transmits data (for example, HTML data or the like) indicative of the site associated with the URL extracted with the process in step S601 and the premium data and the like extracted with the process in step S601, to the portable terminal device 400, through the communication interface 650 and the Internet 500. Then, the microcomputer 610 clears the image information stored in the hard disk drive 620. After the completion of this process, this subroutine ends.

Further, the microcomputer 610 and the communication interface 650 function as benefit information transmission means for transmitting the information (premium data) relating to a predetermined benefit extracted in step S601 to the portable terminal device 400. Namely, the microcomputer 610 and the communication interface 650 function as benefit information transmission means for transmitting information relating to a predetermined benefit to the portable terminal device 400, on the condition that image information associated with predetermined typed of reach effect images is received by the microcomputer 610 and the communication interface 650 as reception means.

In step S805, a data storage process is conducted. In this process, the microcomputer 410 in the portable terminal device 400 stores, in the memory 420, the data transmitted from the server 600 (the data indicative of the site associated with the URL extracted with the process in step S601 and the premium data). Then, the microcomputer 410 displays the site associated with the URL as data, on the liquid crystal panel 460, on the basis of the aforementioned data. Further, the player can acquire the information (premium data), by inputting a predetermined command through operations of the operating portion 470. After the completion of this process, this process ends.

As described above, the two-dimensional codes 300a including output information associated with respective plural types of reach effect images are captured by the portable terminal device 400 from the outside and, as a result, image data based on the any types of the two-dimensional codes 300a is generated, and the server 600 receives image information associated with reach effect images, from the portable terminal device 400, wherein the image information is based on the image data. Then, on the condition that the pachinko gaming machine 10 has received all the image information associated with predetermined types of reach effect images, for example, all 5 types of reach effect images in the present embodiment, waiting-image image data is transmitted to the portable terminal device 400, as a predetermined benefit. Namely, in order to provide a predetermined benefit, the following actions should be performed for predetermined types of reach effect images, which requires the player to make efforts during games. For example, two-dimensional codes 300a associated with plural types of reach effect images are captured by the portable terminal device 400 to generate image data and, then, image information associated with the reach effect images, which is based on the image data, is transmitted to the server 600. As described above, as a condition for providing a predetermined benefit to the player, the player is required to make efforts during games, which provides a new game aspect to the player, thereby enhancing his or her interest in games.

FIG. 28 is a view illustrating an exemplary data table used in step S601 in FIG. 27. As illustrated in FIG. 28, in the data table, image information stored in the hard disk drive 620 (see FIG. 22), URL data and premium data as supply information are associated with one another. For example, image information A as recorded image information, an URL (http://***.***.001.htm), and encouraging image data 1 are stored in association with one another. Similarly, image information B as recorded image information, an URL (http://***.***.002.htm), and encouraging image data 2 are stored in association with one another. Further, image information A, B, C, D and E as recorded image information, an URL (http://***.***.0025.htm), and waiting-image image data are stored in association with one another.

Accordingly, for example, when the image information A is stored in the hard disk drive 620, and the URL (http://***.***.001.htm) as URL data and encouraging image data 1 as premium data are extracted, data indicative of the site associated with the URL (http://***.***.001.htm) and the encouraging image data 1 are transmitted to the portable terminal device 400. Also, when the image information A, B, C, D and E is stored in the hard disk drive 620, and the URL (http://***.***.025.htm) as URL data and the waiting-image image data as premium data are extracted, data indicative of the site associated with the URL (http://***.***.025.htm) and the waiting-image image data are transmitted to the portable terminal device 400.

While, in the present embodiment, encouraging image data, waiting-image image data and cellular phone ring melodies are employed as premium data which is information, the present invention is not limited thereto. The premium data may be various types of data such as service points, game information, waiting-image image data, URL data, and various types of programs.

Further, while, in the present embodiment, on the condition that the server 600 has received all the image information associated with five types of reach effect images, the waiting-image image data is transmitted to the portable terminal device 400 as a predetermined benefit, the present invention is not limited thereto. Namely, a predetermined benefit may be transmitted to the portable terminal device 400, on the condition that the server 600 has received four or less types of image information or six or more types of image information which are associated with reach effect images.

Further, while, in the present embodiment, when the server 600 has not received all the image information associated with five types of reach effect images, encouraging image data is transmitted to the portable terminal device 400, it is essential that such encouraging image data is transmitted.

Further, while in the aforementioned embodiment a first type of pachinko gaming machine has been exemplified, the present invention is not limited thereto and may be applied to other types of pachinko gaming machines such as a second type of pachinko gaming machine referred to as a blade type machine, an aircraft type machine, a third type of pachinko gaming machine referred to as a right providing type pachinko gaming machine or other types of pachinko gaming machines.

Further, while in the present embodiment the present invention is applied to a gaming machine such as a pachinko gaming machine, it maybe applied to a pachi-slot gaming machine or a gaming machine.

Also, while in the present embodiment 7-segment LEDs are employed as the displaying portion of the number-of-rounds display device 51, the present invention is not limited thereto and may employ other types of displaying portions, such as a liquid crystal display panel, a picture tube including a CRT (Cathode Ray Tube), dot LEDs, ELs (Electronic Luminescents), plasma or the like.

While an embodiment of the present invention has been described, the embodiment has been merely exemplified as a concrete example and is not intended to limit the present invention. Namely, the present invention is a gaming machine comprising display means for displaying various types of images including identification information images which are to be variably displayed and statically displayed and display control means for displaying, on the display means, an output information image including predetermined information as one of the aforementioned identification information images, in such a manner that it can be captured by image pickup means from the outside, wherein the concrete structures of the display means and the display control means can be arbitrarily changed in design.

Further, the effects described in the embodiments of the present invention are only most preferred effects of the present invention, and the effects of the present invention are not limited to those described in the embodiments of the present invention.

What is claimed as new and desired to be secured by Letters Patent of the United States is:

1. A gaming machine comprising:
display means for displaying plural types of images including plural types of reach effect images displayed until the execution of special games advantageous to a player;
display control means for conducting a control for displaying, on said display means, any types of output information images, out of plural types of output information images including output information associated with said respective plural types of reach effect images, in such a manner that the output information images can be captured with image pickup means from the outside;
reception means for receiving, from outside, information relating to image data based on said any types of output information image, the image data obtained by capturing by said image pickup means, as an image information associated with said reach effect images; and
control means for conducting a control for providing a predetermined benefit, on the condition that said reception means has received image information associated with predetermined types of reach effect images.

2. A game system comprising:
a gaming machine including display means for displaying plural types of images including plural types of reach effect images displayed until the execution of special games advantageous to a player, and display control means for conducting a control for displaying, on said display means, any types of output information images, out of plural types of output information images including output information associated with said respective plural types of reach effect images, in such a manner that the output information images can be captured with image pickup means from the outside; and
a server capable of transmitting and receiving information to and from the outside via a communication line,
wherein
said server includes:
reception means for receiving, from outside, information relating to image data based on said any types of output information image, the image data obtained by capturing by said image pickup means, as an image information associated with said reach effect images; and
benefit information transmission means for transmitting, to the outside, information relating to a predetermined benefit, on the condition that said reception means has received image information associated with predetermined types of said reach effect images.
